(19) United States
(12) Patent Application Publication
(10) Pub. No.: US 2007/0267402 A1
(43) Pub. Date: Nov. 22, 2007

(54) Oven With An Articulating And Retractable Door

(76) Inventors: Gary V. Harned, Grand Junction, CO (US); Kim A. Williams, Grand Junction, CO (US); Kenneth W. House, Fort Collins, CO (US); Douglas P. Collins, Loveland, CO (US)

Correspondence Address: LEYENDECKER LEMIRE & DALEY, LLC, C/O PORTFOLIO IP, P.O. BOX 52050, MINNEAPOLIS, MN, 55402, US

(21) Appl. No.: 11/685,064

(22) Filed: Mar. 12, 2007

Related U.S. Application Data
(63) Continuation-in-part of application No. 11/435,561, filed on May 17, 2006, now Pat. No. 7,227,101.

(51) Int. Cl. A21B 1/00; A21B 1/22

(52) U.S. Cl. 219/392; 219/391; 219/408

(57) ABSTRACT

In one embodiment of the present invention, an oven having a flexible and retractable door is described. The oven door is adapted to move from a closed position wherein it effectively closes an open side of the oven chamber and an open position wherein the door is retracted into the body of the oven, typically below the oven chamber. In variations, an electric motor is provided to selectively move the oven door between the open and closed positions. In other variations, the oven includes an oven rack that is moveable between extended and retracted positions by way of a second electric motor.

### REFERENCE TO RELATED APPLICATIONS

The application is a Continuation in Part (CIP) of U.S. patent application Ser. No. 11/435,561, which shares the same name and inventors, and excepting any new matter contained herein, this application claims priority to and incorporates by reference the above referenced application.

### FIELD OF THE INVENTION

This invention generally relates to ovens and oven doors.

### BACKGROUND

Most residences in the United States include kitchens with either one or more ovens built in to the kitchen cabinetry, or a range comprising a cook top and an oven nestled in-between sections of countertop. Almost universally, these ovens include a planar flat rectangular door that is connected to the remainder of the oven by one or more hinges mounted on one edge of the door, most often on the bottom edge.

Most typically, an oven door in its open position is horizontally disposed extending outwardly from proximate the bottom of the oven chamber. Accordingly, when the oven is opened to insert or remove food products from the oven, the door projects outwardly from the chamber into kitchen.

On ranges in particular, the oven door is elevated off of the floor only about a foot and is easily accessible by children who can be seriously burned by touching the door's upwardly facing inner surface. Further, children have caused prior art ranges to tip over onto them by climbing onto the open door of the oven. Additionally, a cook must access the oven chamber from the side rather than directly from the front of the oven. If the cook has to reach diagonally across the oven, he or she could lose balance and fall on to the hot exposed inner surface.

In galley-style kitchens, the door, which can project 20″ or more outwardly when open, can effectively obstruct a cooks ability to move unhindered about the kitchen when removing or placing food products in the oven. Accordingly, the placement of an oven in a small kitchen is often dictated by space constraints rather than the optimum location relative to the other appliances and counter space for efficient food preparation.

Despite these drawbacks to the conventional oven door, very few alternative oven and oven door combinations have been proposed. U.S. Pat. No. 6,029,649 and published U.S. patent application 2003/0146203 both teach generally arcuate rigid doors that slide over a arcuate housing between open and closed configuration, but in order for this oven and door combination to work there must be space above the top (or bottom) of the oven for the door to rotate to the open position. Further and even more disadvantageous, the configuration of the oven's exterior must be cylindrical. In order for such an oven to provide comparable space in the oven chamber as a traditional range or built in oven, the diameter of the oven must be disproportionably large. Given that space is at a premium in most residential kitchens, increasing the size of an oven is not practical. Because of these drawbacks, the ovens of the aforementioned patent and patent application relate to countertop ovens, more commonly referred to as toaster ovens, where the size of the oven chamber is not extremely critical.

Neff, a German appliance company, offers built in ovens and ranges that have a rigid door that opens in a similar manner as conventional doors but once open, the door can be slid horizontally into a chamber located beneath the oven chamber. This oven and door design ameliorates many of the problems of a conventional door when the door is slid into the associated door chamber, but given the extra step necessary to slide the door away and extra time involved in sliding the door away, it is anticipated that most cooks would not bother very often. When the door is not slid away, it presents the same space and safety issues as a conventional oven door. Further, the multifunction hinge mechanism that permits the door to be rotated open and then slid inwardly, is rather complex and more prone to malfunction than a hinge on a conventional door.

### SUMMARY OF THE DRAWINGS

FIG. 1 is an isometric front view of a range according to an embodiment of the present invention.

FIG. 2 is an isometric front view of an in-the-wall oven according to an embodiment of the present invention.

FIG. 3 is an isometric front view of an oven unit that can be utilized, for example, in either the range or in-the-wall oven of the previous Figures according to an embodiment of the present invention.

FIG. 4 is a partially exploded view of an oven unit according to an embodiment of the present invention.

FIG. 5 is a side view of the header member of the oven unit according to an embodiment of the present invention.

FIG. 6 is a side view of a door segment of the oven unit according to an embodiment of the present invention.

FIG. 7 is a cross sectional side view of the header member of FIG. 5 according to an embodiment of the present invention.

FIG. 8 is a cross sectional side view of a door segment of FIG. 6 according to an embodiment of the present invention.

FIG. 9 is a cross sectional side view of two adjacent door segments of the oven unit according to an embodiment of the present invention: the top segment being non-windowed; and the bottom segment having windows.

FIG. 10 is a partial isometric view illustrating a door segment and the left side of the door frame including the left guide track of the oven unit according to one embodiment of the present invention.

FIG. 11 is a similar partial isometric view as FIG. 10 further illustrating a windowed door segment coupled to a non-windowed segment.

FIG. 12 is a partial close-up isometric view taken from FIG. 11 as indicated on FIG. 11 illustrating the connection between door segments.

FIGS. 13 and 14 are top views taken along line 13-13 of FIG. 3 illustrating (i) a door segment interfacing with its associated guide track and (ii) a gasket for sealing against the door by way of a solenoid mechanism with FIG. 13 showing the gasket compressed against the door to form a seal and FIG. 14 showing the gasket retracted according to an embodiment of the present invention.

FIGS. 15 and 16 are partial isometric views of the oven unit illustrating the motor-driven extensible and retractable oven rack according to an embodiment of the present invention.

FIG. 17 is an isometric view of the oven unit's guide track according to an embodiment of the present invention.

FIGS. 18, 19 & 20 are side views of the oven unit illustrating the doors opening and closing mechanism with the door in various positions between open and closed according to an embodiment of present invention.

FIG. 21 is an isometric view of the bottom door segment according to an embodiment of the present invention.

FIG. 22 is a partial isometric rear view of the lower door segments and the pivotal joint therebetween according to an embodiment of the present invention.

FIG. 23 is an isometric rear view of the lower door segments and the pivotal joint therebetween according to an embodiment of the present invention.

FIG. 24 is an isometric front view of an oven according to one embodiment of the present invention.

FIG. 25 is an isometric side view of selected portions of the internal structure of the oven when the retractable door is in a substantially open position according to an embodiment of the present invention.

FIG. 26 is an isometric side view of selected portions of the internal structure of the oven when the retractable door is in a substantially closed position according to an embodiment of the present invention.

FIG. 27 is a cutaway side view of the oven indicating airflow within the oven and closure according to an embodiment of the present invention.

FIG. 28 is a cutaway of two door segments including an exploded side view of the front face of the door segments according to an embodiment of the present invention.

FIG. 29 is a cutaway top view of a portion of the oven illustrating the retractable side seal its retracted configuration according to an embodiment of the present invention.

FIG. 30 is a cutaway top view of a portion of the other illustrating the retractable side seal in its deployed configuration according to an embodiment of the present invention.

FIG. 31 is a partial isometric side view illustrating a portion of the oven framework and the topmost door segment when the door is in the closed position according to an embodiment of the present invention.

FIG. 32 is an isometric view including to close views of the side seal assembly according to an embodiment of the present invention.

FIG. 34 is a partial cutaway side view illustrating the topmost door segment and the header assembly with the door partially open according to an embodiment of the present invention.

FIG. 35 is a partial cutaway side view illustrating the topmost door segment in the header assembly with the door substantially closed according to an embodiment of the present invention.

### DETAILED DESCRIPTION

One embodiment of the present invention comprises an oven including an articulated door that retracts into the space located below the oven box. Accordingly, easier and more convenient access to the oven chamber is provided. Further, the safety hazard presented by an open door extending out into the kitchen is eliminated.

The one embodiment door is preferably operated by an electric motor such that the opening and closing of the door can be facilitated by any number of suitable means, such as but not limited to (i) depressing a button, (ii) flipping a switch, (iii) activating a remote control, and (iv) providing a voice command. This can be advantageous when the a user is holding a large pan with a heavy food product in the pan as he/she can push the button with a finger without having to set the pan down on a nearby counter. Further, because the motor of the one embodiment is microprocessor controlled, the need for a separate latch to prevent the oven from being opened during a self cleaning cycle is eliminated. Instead, the controller simply disables the buttons relating to the opening and closing of the door during the cycle.

In a variation of the one embodiment, the movement of the lower oven rack is also motorized, such that the rack will move from its normal fully retracted position in the oven chamber to an extended position wherein at least half of the rack extends beyond the door opening. This variation is particularly useful for handicapped person who might have difficulty reaching in and out of a traditional oven and removing a heaving pan, such as one having a turkey in it, therefrom. The extending oven rack is also potentially useful for people with bad backs as heavy loads can be lifted more easily without straining the back, such as would be the case from bending over and reaching into an oven to remove a heavy pan.

In other variations and embodiments, such as a wall or cabinet-mounted oven, the controls for operating the door and the oven are located at the bottom of the oven as are the associated status display panels. Accordingly handicapped or people of shorter than average stature can easily reach the panel to operate a cabinet-mounted oven with relative ease. Traditional prior art household cabinet-mounted ovens do not facilitate the mounting of the controls at the bottom as the oven door essentially would cover and hinder access to bottom mounted controls.

In yet other variations and embodiments, the forward facing front surface of the oven generally surrounding the door comprises a decorative mask comprises at least two layers wherein a first layer comprises a material or coating exhibiting a desirable appearance, such as a sheet of stainless steel and the second layer, which covers the appearance layer, comprises a transparent material, most frequently glass, that protects the first layer. Certain types of finishes, such as stainless steel that readily show smudges and fingerprints, are very difficult to keep clean. Glass on the other hand is very easy to clean. By covering the finish in glass, a door that presents the current in vogue appearance can be provided while facilitating easy cleaning and maintenance of the oven face. Certain embodiments permit the second layer of glass to be removed facilitating the replacement of the first layer thereby allowing the appearance of the oven to be changed and updated as necessary. It is to be appreciated that this particular improvement is applicable to prior art ovens as well as the other embodiments and variations described herein.

The advantages provided, the various embodiments described above and herein are not intended to be construed as limiting. Rather, numerous variations and numerous embodiments have been contemplated that read upon the appended claims and are intended to be within the scope of the invention.

### Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “one variation”, “a variations” and similar phrases mean that a particular feature, structure, or characteristic described in connection with the embodiment is included in at least an embodiment of the invention. The appearance of the phrase “in one embodiment” in various places in the specification are all not necessarily meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

The terms “switch” or “switches” as used herein to refer to any device for controlling the flow of current through an electrical trace and is not limited to any particular type of configuration of a switch including but not limited to toggle switches, buttons, rocker switches and touch sensitive switches.

The phrase “oven chamber” as used herein refers to the structure enclosing the heated space within the oven. In contrast, the term, “oven enclosure” refers to any structure partially or substantially enclosing not only the oven chamber but also any oven framework and components located outside of the oven box, such as but not limited to, in certain embodiments: the door motor, the linkage and other components associated with the opening and closing of the door, and the oven's control systems. The phrase “oven box” as referred to herein refers to either or both the oven chamber and the oven enclosure depending on the context of use.

### An Embodiment of a Range or Oven Incorporating an Articulating and Retractable Door

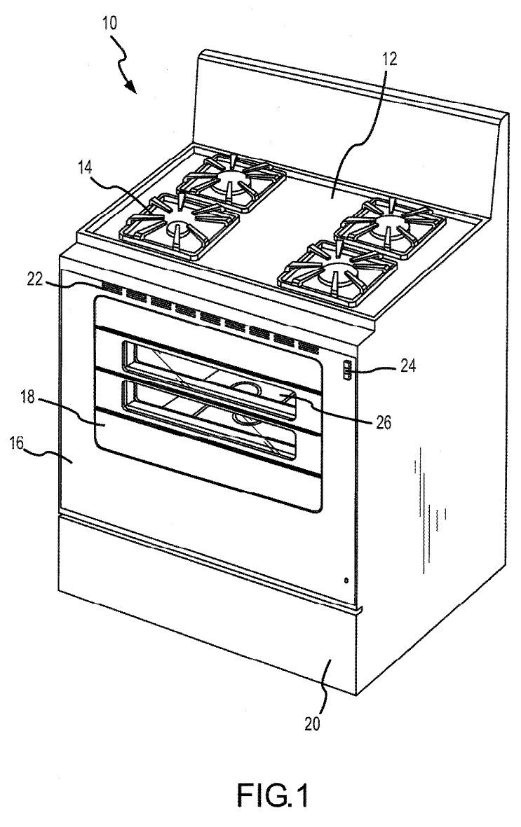

Referring to FIG. 1, a range 10 according to an embodiment of the present invention is illustrated. The range typically comprises a cook top 12 having a plurality of gas or electric burners 14. Controls in the form of dials and switches (not shown) are also provided to control the operation of the cook top and an associated oven chamber 26 located below the cook top. The front 16 of the range includes a retractable door 18 comprising a plurality of pivotally connected door segments. To ensure that the door does not become hot enough to seriously burn a person, such as a child, who touches the door while the oven is in use, an air path is provided that uses convective forces to pull cooler air from beneath the door and exhaust it above the door through a plurality of vent slots 22. In other variations the air path can be ducted to the rear or side of the oven instead of out the front of the oven. As necessary, fans can be provided to assist and facilitate the flow of air. The door is opened and closed through the actuation of an electric motor. Buttons 24 or other switches are provided to permit a user to retract to close the door as desired. The placement of the buttons or switches can vary and are in variations coupled with an electronic control circuit (or control system) that monitors the opening and closing of the door through strategically placed infrared and other sensors (not shown). In certain variations, a drawer 20 is provided below the oven chamber in which pots and pans can be stored.

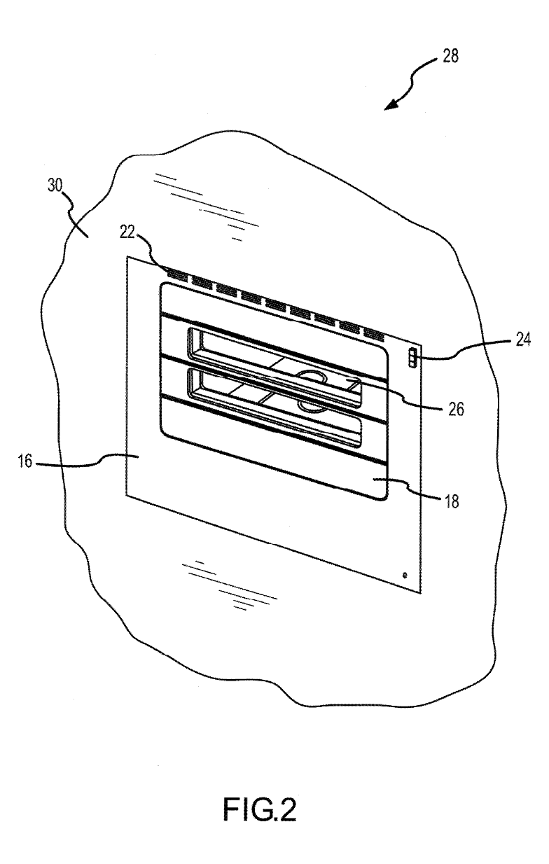

In another embodiment of the present invention is illustrated in FIG. 2 wherein the oven 28 is not coupled with a cook top but is integrated into a wall 30 or cabinet in the associated kitchen. In variations the in-the-wall oven can comprise an oven with a single oven chamber 26 or it can comprise a double oven having two oven chambers that are typically vertically stacked relative to each other. Aside from being located in a wall, the oven is substantially similar to the oven of the range 10 having: (i) a front side 16 with a retractable door 18 comprising a plurality of door segments; (ii) vent slots 22 above the door to exhaust air that is drawn through the door to cool the exterior surfaces of the door; and (iii) switches or buttons 24 for opening and closing the door. Additionally, controls related to the operation of the oven are provided but these have been omitted from the figure for clarity.

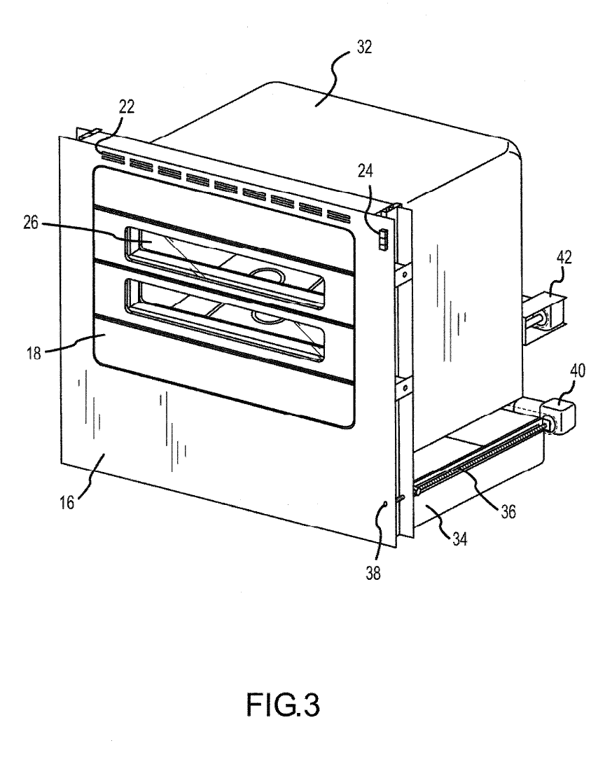

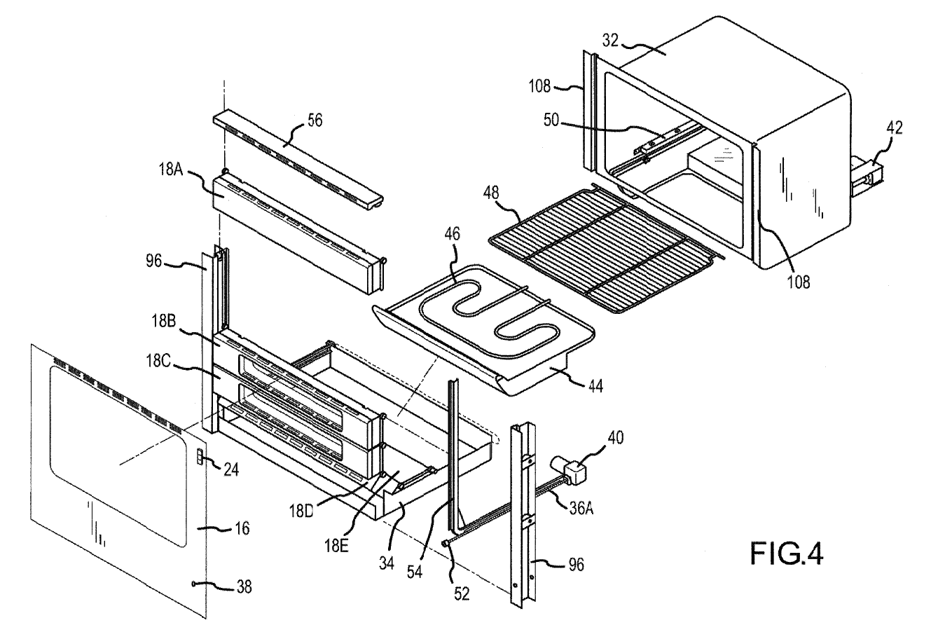

FIG. 3 is an illustration of the in-the-wall oven embodiment 28 removed from the wall 30. It is appreciated that the illustrated structure is generally similar to that of a range 10 as well. The oven box assembly 32 that defines the top, bottom, back, left and right sides of the oven chamber 26 is shown. The box assembly can be fabricated from nested steel boxes that are separated by an air space or a high temperature insultative material. Alternatively, the box may comprise a single steel box that is covered externally with a high temperature insulative material such as fiberglass. Two electric motors 40 & 42 are illustrated. The lower motor 40, which is shown coupled to a lead screw 36A, is used for opening and closing the retractable door 18. The upper motor 42 provided in certain variations is used to extend and retract an oven rack 48 (see FIG. 4). The operation of both motors and their associated hardware is discussed below in greater detail.

FIG. 4 illustrates the oven of FIG. 3 in a partially exploded view. As shown the bottom of the box assembly 32 is open and a separate oven pan 44 or heat shield is received in the box to fully enclose the chamber 26. The removable oven pan facilitates the cleaning of the glass on the inside surfaces of the windowed door segments 18B&C once the door has been fully retracted. A bottom heating element 46 is typically provided above the oven pan and is received into a suitable receptacle (not shown) at the rear of the box assembly. In variations of the oven, an upper element (not shown) is also provided for use to broil foods. A single motorized oven rack 48 is shown that is supported by a roller assemblies 50 located on the left and right sides of the interior of the box assembly. In place of the roller assemblies support ridges of a conventional design may be integrally formed in the inner box to provide support for the rack. Additional supports and racks are typically provided although they have been omitted from the illustrations for clarity. The additional racks may be of the traditional manually operational variety or they may incorporate an automated extension and retraction mechanism using a motor similar to the mechanism discussed herein.

The actual design and configuration of the oven box assembly illustrated in FIG. 4 and other Figures is merely exemplary and may vary significantly as would be obvious to one of ordinary skill in the art of oven design with the benefit of this disclosure.

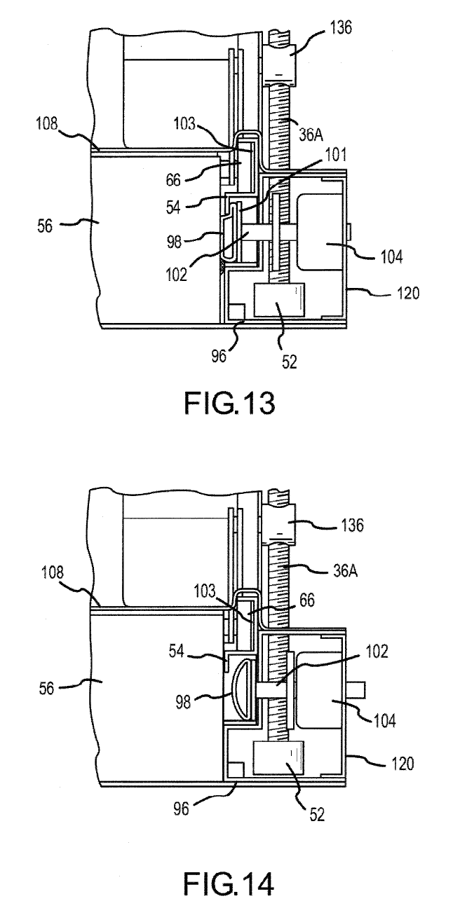

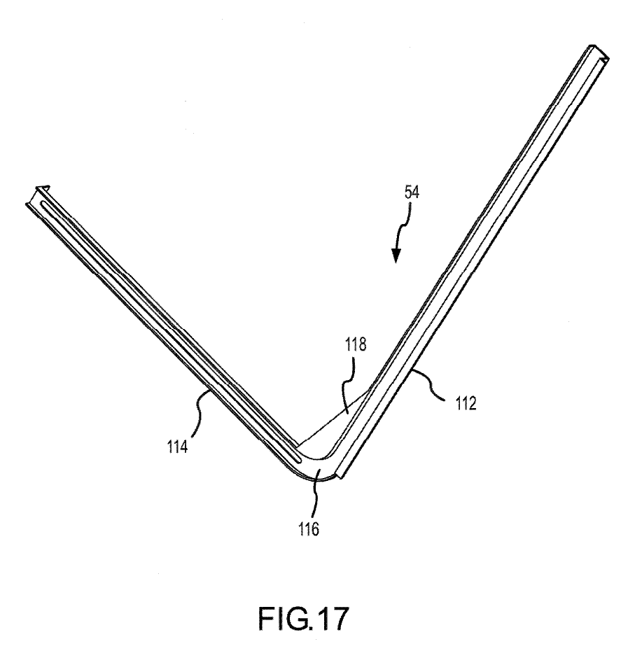

Still referring to FIG. 4, left and right vertical door frame members 96 are provided. The frame members are coupled to an outwardly-extending flange member 108 that comprises part of the oven box by any suitable means, such as spot welding, riveting or bolting (also see FIG. 13). These members are typically stamped out of steel sheet but can also be manufactured by any suitable means using any suitable material. Functionally, the left and right frame members provide rigidity and support for the vertical portions 112 (see FIG. 17) of the left and right door track guides 54 along which segments 18A-E of the door are guided between the closed and retracted positions.

Also part of the oven door frame, a header member 56 is provided that is connected to the top end of both vertical frame members. In addition to providing door frame rigidity, the header member, which is substantially hollow, receives the airflow from the air path provided in the door segments and directs it out of the vent slots 22 on the front side 16 of the oven. As discussed in greater detail below, the header also includes a door seal gasket 58 (see FIG. 5) that seals the oven chamber along the top door segment 18A. The header is typically comprised of steel and is fabricated using conventional means.

To complete the oven door frame the bottom ends of the left and right vertical frame members 96 are coupled to a base pan 34. The primary functionality of the base pan is to separate the oven unit from whatever is located below. For instance, where the oven unit is part of a range, such as shown in FIG. 1, the bottom side of the base pan forms the top side of the oven pan drawer 20. It is appreciated that in certain variations where protection of the door and its associated mechanism is not required from below the pan may be eliminated by substituting an elongated member having dimensions generally similar to the header member that spans between the bottom edges of the vertical frame members to complete the oven door frame.

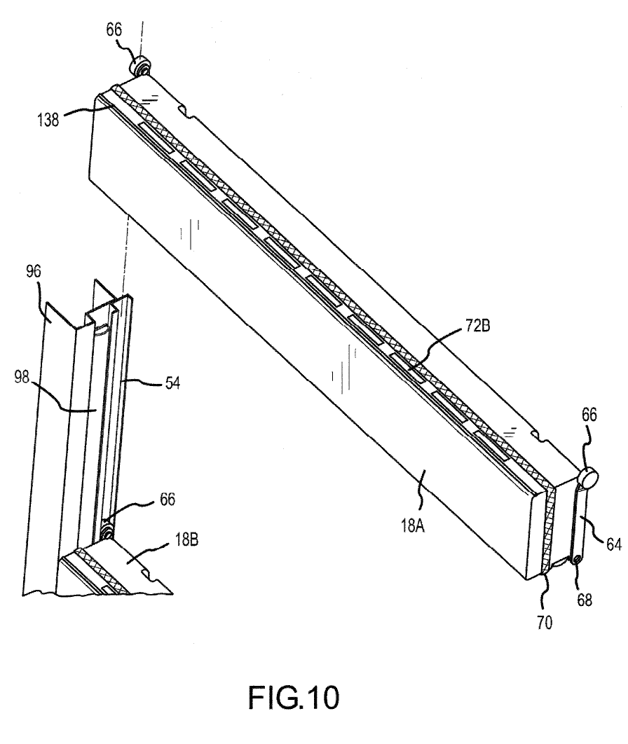

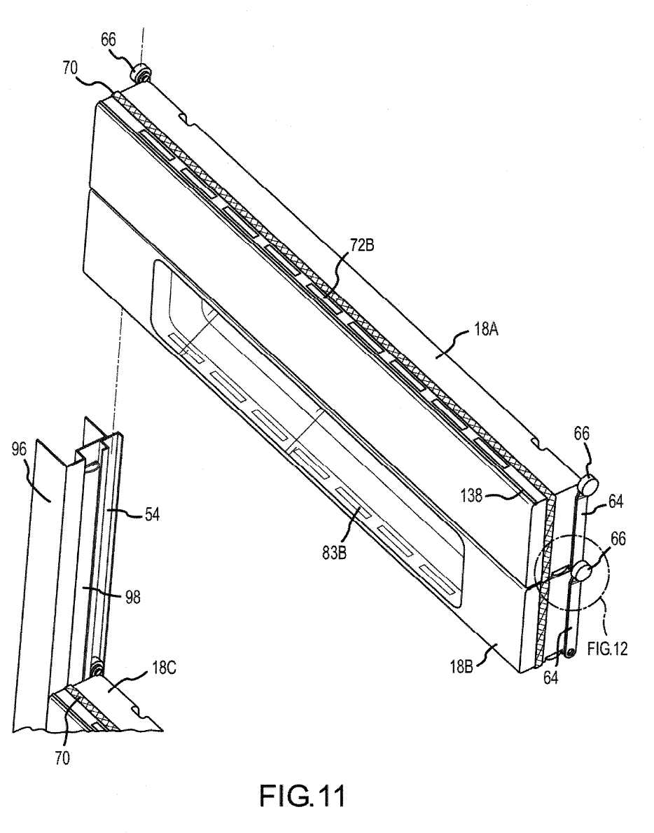

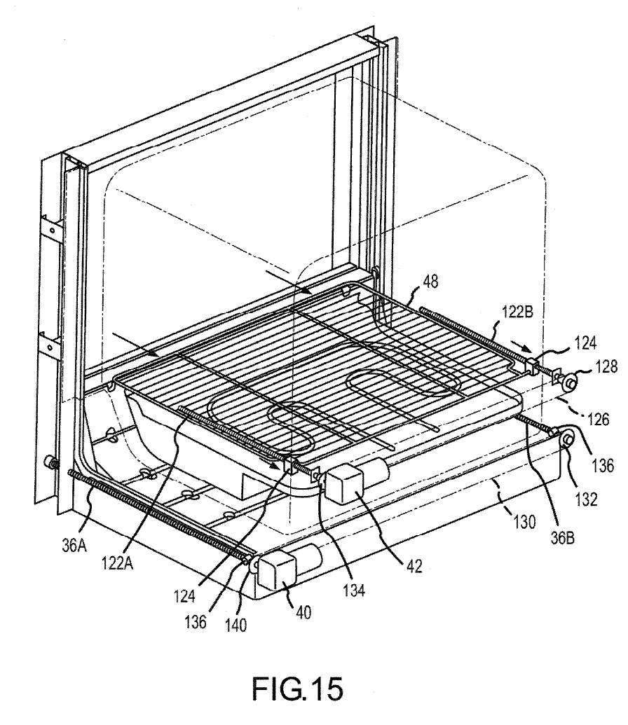

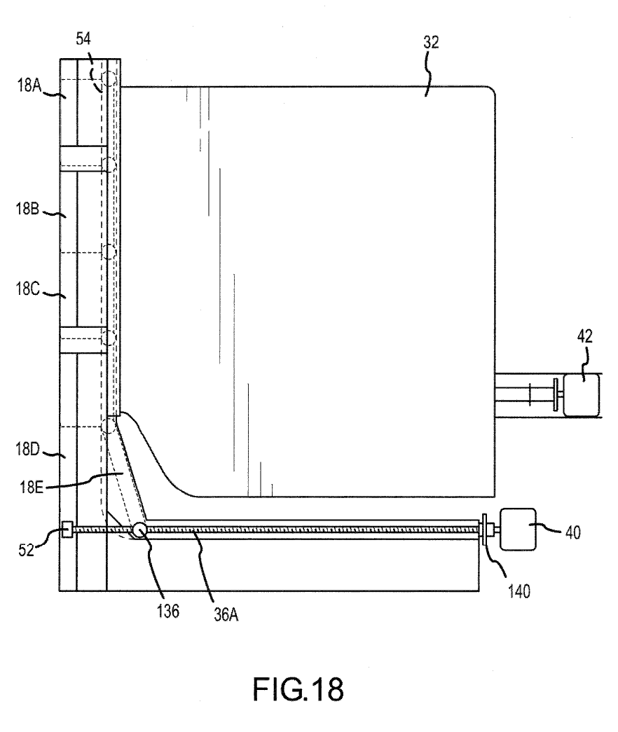

As indicated above, the vertical portions of the left and right track guides 54 are attached to the vertical frame members 96 as shown, for instance, in FIGS. 10 and 13. As shown in FIG. 4 and also FIG. 17, each frame member is substantially L-shaped having a substantially vertical section 112 and a substantially horizontal section 114 integrally joined together at a radiused corner 116. To further strengthen the track members, the corner includes a gusset 118 in certain variations. As shown in FIG. 13, the track guide has a C-shaped cross section adapted to receive a wheel 66 of each of the interconnected door segments 18A-E therein. Effectively, the guide tracks through the wheels support the door within the oven and facilitate movement of the door between: (i) its closed position with the top four door segments 18A-D being substantially vertically orientated (for example, see FIG. 18); and (ii) its retracted position with the bottom three door segments 18C-E being substantially horizontal and all segments being located below the oven box assembly's front opening (for example, see FIG. 15).

As illustrated in FIG. 13, the widths of the oven door segments including each segments left and right wheels 66 are slightly less than the width of the corresponding distance between the back sides of corresponding left and right guide tracks thereby leaving a small space 103 between the end of the wheel and the back side of each track guide to allow the door to thermally expand when heated without negatively impacting the door's operation.

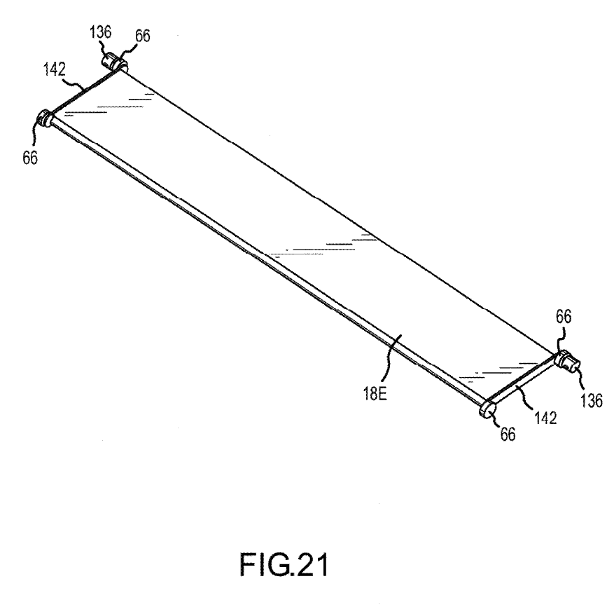

To move the door 18 between its open and closed positions a motor driven mechanism is provided. The aforementioned lower motor 40 and associated left and right lead screws 36 A&B are activated to pull left and right nuts 136 (see FIGS. 15 & 19) that are threaded over the respective lead screws. The nuts are pivotally coupled to the left and right bottom corners of the lowest door segment 18E (see FIG. 21). The left lead screw is axially coupled with the shaft of the lower motor to turn in concert therewith by a pulley coupler 140 as can be seen in FIGS. 15 & 18. Referring primarily to FIG. 15, the pulley coupler includes a cog over which a chain 130 or tensioned belt is received. The chain extends from the right side to the left side of the oven generally behind the base pan 34 and is coupled to another pulley 132 on the right side of the oven. The right pulley is in turn coupled to the right lead screw 32B. Accordingly, when the lower motor is activated, such as by depressing the appropriate buttons 24 on the front side 16 of the oven, the lead screws rotate and cause the door 18 to be opened or closed depending on the direction of rotation of the lead screws. The lower motor may include a gear box adapted to facilitate the rotation of the lead screws at a desired rate as well as ensure sufficient torque is provided to open and close the door.

Referring to FIGS. 4 and 18, the front end of the right lead screw 36A includes a socket head 52 that is accessible through an opening 38 in the front side panel 16. Accordingly, a user can, if necessary, open the door 18 manually, such as in a situation where there is a power failure or in the very unlikely instance of a motor failure. In other variations, a battery backup power supply (not shown) may be included with the oven with a large enough capacity to permit a user to open and close the oven door a limited number of cycles in the event of a power failure.

The oven door 18 as shown in FIG. 4 comprises five door segments 18A-E. The top four segments 18A-D form the portion of the door that covers the oven chamber 26 when the door is closed and accordingly are insulated and adapted for exposure to the high temperatures of the oven chamber. As illustrated two segments 18B&C of the top four segments have windows permitting a user to view the food items being cooked in the oven chamber, and the other two segments 18A&D are non-windowed. In variations of the oven, any desirable combination of windowed and non-windowed segments can be specified. The lowest door segment 18E (as also shown in FIG. 21) serves to interface with the motor driven mechanism for opening and closing the door. Because this segment is never directly exposed to the oven chamber or to a user on the outside of the oven, it is typically comprised primarily of uninsulated steel plate.

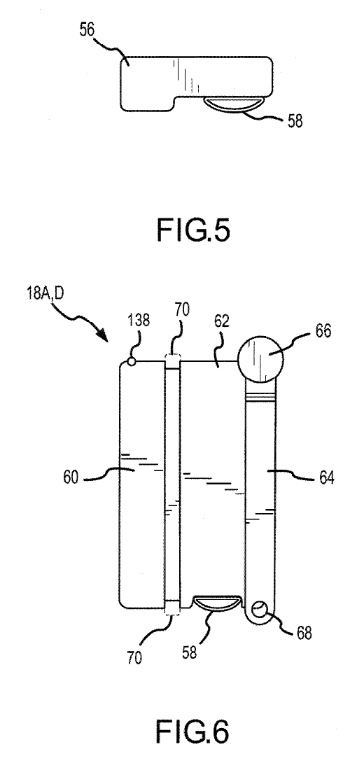

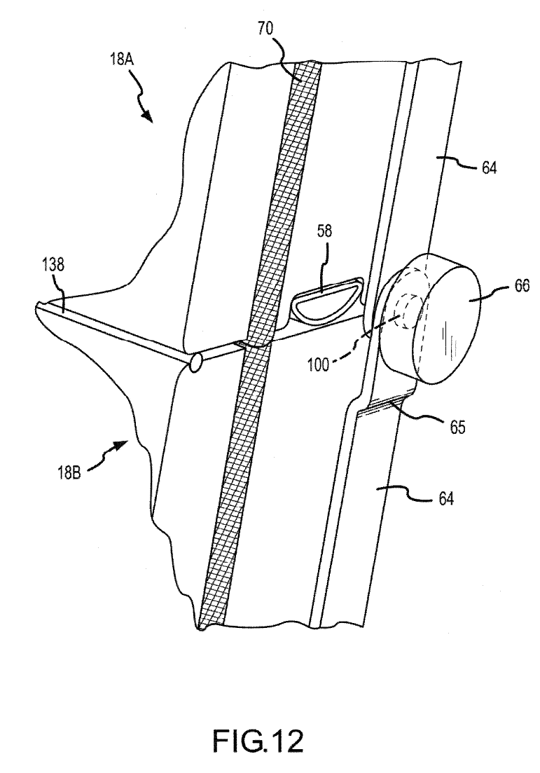

The four upper segments 18A-D are pivotally coupled to each other through brackets 64 located on the left and rights ends of each segment proximate the segment's rear face as best shown in FIGS. 6 & 10. The bracket is attached to the door segment by any suitable means, such as but not limited to spot welding and rivets. Each bracket is generally planar but jogs outwardly from the segment proximate the top end thereof as best illustrated in FIG. 12. The jog 65 permits the bottom end of another bracket of the above adjacent door segment to be received behind the jog to facilitate the coupling of the brackets and the segments. The top and bottom ends of each bracket include holes 68 for receiving an axle 100 of an associated guide wheel 66 therein. To assemble the door segments, an upper segment is placed above a lower segment and the associated brackets and their holes are aligned. The axle of a guide wheel is placed in the aligned holes on both the left and right sides of the segments. One or more c-clips (not shown) can be used to hold the wheel and its axle in either one or both of the holes of the associated brackets. Alternatively, the axle may not be secured to either bracket but rather held in place when the wheels and door segments have been received into the left and right guide tracks as the side to side movement of the door segments is not sufficient to dislodge the axle.

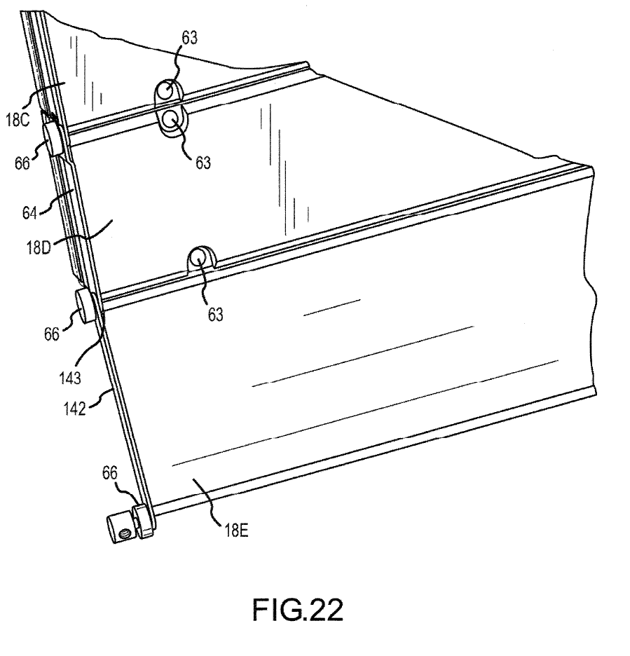

Referring to FIG. 21, the bracket 142 of the lowest door segment 18E differs slightly from the brackets used with the other door segments 18A-D. Specifically, the bracket is completely planar having no outwardly jogs at either end thereof. It is appreciated, however, that the bottom door segment 18E is slightly wider than the other segments, and accordingly, the wheels 66 fitted to both ends of the bottom door segment are fully aligned with the wheels of the upper segments having brackets with jogs. Further unlike the other segments, the bottom end of the bottom segment's bracket includes a wheel 66 attached thereto. Referencing FIG. 22, a slot is cut in bottom door segment adjacent the top of the bracket and the associated wheel so that the bottom portion of the bracket 64 of the above adjacent door segment 18D can be received therein to couple the respective door segments together. The respective threaded left or right nut 136 is pivotally attached to the bottom of the bracket 142 adjacent and coaxial with the associated bottom wheel 66. As described above, the door is opened and closed by rotating the lead screws 36A&B on which the nut is threaded to push or pull the nut, the bottom door segment 18E and consequently the entire door 18 between its open and closed positions.

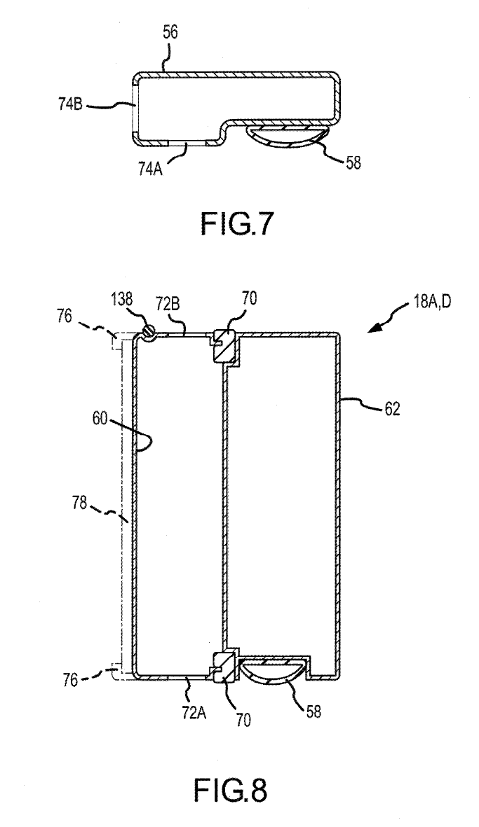

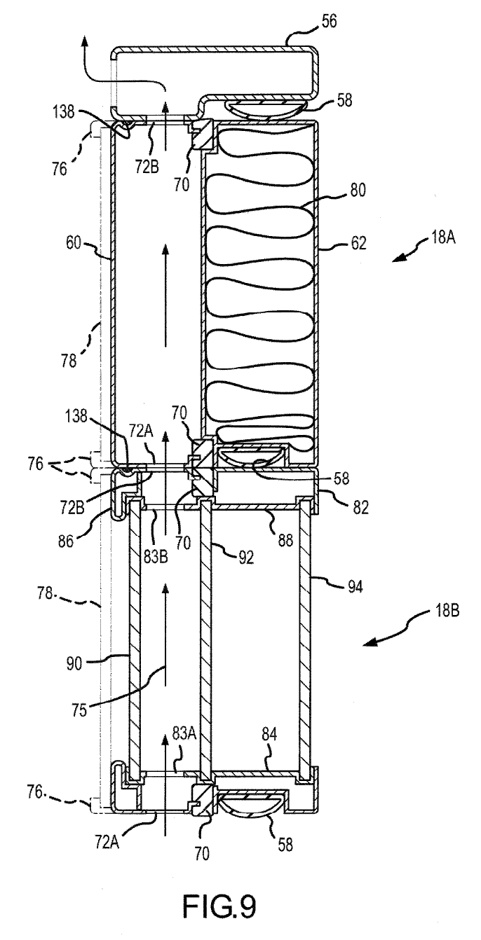

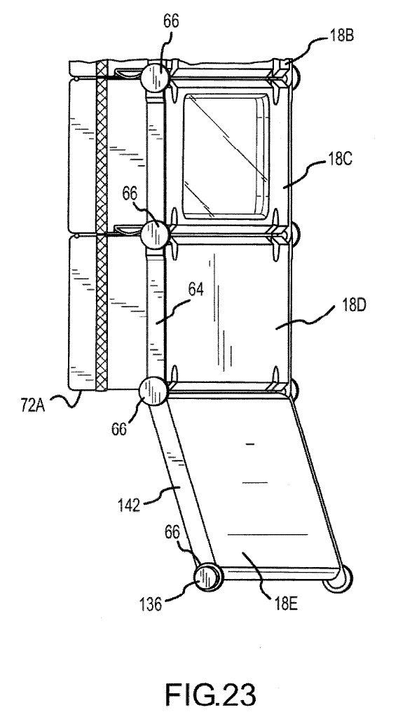

Side and cross sectional views of a typical non-windowed door segment 18A, D are illustrated respectively in FIGS. 6 and 8. The typical door segment includes both a front section 60 and a rear section 62 that are each individually fabricated, typically from sheet steel stock, and later coupled together in a manner that minimizes the flow of heat from the rear section to the front section. It is to be appreciated that while these sections are typically fabricated from sheet steel, they can be fabricated from other metals and/or other processes as well. The front section forms the exterior surface of the door and encloses a convective air path wherein cooler air is funneled from vents 72A in the bottom of the lowest vertical door section 18D when the door is closed (see FIG. 23) upwardly through each section and eventually into the header member (see FIGS. 7 & 9) and exhausted out of the oven through exhaust vents 74B in the header and the vent slots 22 on the front side. Accordingly, a substantial portion of the heat from the rear section 62 is transferred to the air flow and not transferred to the front section thereby keeping the front section 60 relatively cool. The air flow through the upper door segments 18A&B and the header member 56 is illustrated by arrows 75 in FIG. 9.

To facilitate vertical air flow across the door segment 18A&D when the door 18 is closed a series of inlet vents 72A are provided on the bottom side of the front section and a corresponding series of outlet vents 72B are provided on the top side of the section as is illustrated in FIGS. 8 & 10. A small arcuate depression extends lengthwise from left to right along the top side of the front section proximate the front edge thereof. A cylindrical gasket 138 typically comprised of a high temperature elastomer, such as but not limited to Viton is received in the depression. When the door 18 is in its closed position as shown for instance in FIG. 9, the top side of a lower door segment is in contact with the bottom side of the above adjacent door segment or the header member 56 in the case of the top door segment 18A. The cylindrical gasket compresses against the adjacent bottom side, and accordingly, the gasket seals the joint between the adjacent segments to prevent a portion of the air flow from leaking out of the air path at the door segment intersection.

Referring back to FIGS. 6 & 8, the front section 60 is coupled to the rear section 62 by way of an intervening seal 70. The intervening seal is fabricated from a material having a low thermal conductivity when compared to the thermal conductivity of the steel or other material comprising the front and rear sections. The material can comprise any high temperature material low conductivity material, such as a fiberglass felt or other material commonly used in the industry. As best shown in FIG. 8, the front and rear sections are never in direct contact with each other. The front section is secured to the rear section using a small number of screws or rivets and these fasteners typically represent the only points where a metal to metal thermal transfer path is provided between the sections. Accordingly, the amount of thermal energy conductively transferred between the sections is very small helping to maintain the front section at a substantially lower temperature than the rear section.

The rear section 62 is typically in the form of a box structure having a front surface that forms the back side of the air path and a rear surface in contact with the heated air of the oven chamber 26. As discussed above brackets 64 are attached to the left and right sides of the rear section proximate the rear surface. An indentation extends the entire length of the bottom surface in which a large rear primary door seal gasket 58 is received. In some of the figures, the gasket is omitted for clarity. As mentioned above, a door seal gasket is also provided on the bottom side of the header member 56. The door seal gaskets are typically comprised of a fiberglass or metal woven braid that compresses as necessary when placed in contact with the top surface of an adjacent door segment. Although the gaskets are shown as being hollow, they can also be filled with a generally compressible high temperature material, such as fiberglass or rock wool fill, such as is normally used in the industry. It is to be appreciated that the door seal gasket is provided on the bottom surfaces of the rear section 62 on door segments 18A-C. Door segment 18D does not require a door seal gasket on its rear section's bottom side as the bottom side does not butt up against the lowest door segment as shown in FIG. 23. While referencing FIG. 23, it is noted that relatively cool air is drawn into the inlet vent 72A to begin its flow along the air path defined by the front sections 60 of the top four door segment 18A-D to be eventually exhausted out of the header member 56. Although the rear section is shown as hollow in FIG. 9, it is typically filled with a suitable high temperature insulation 80, such as but not limited to fiberglass as shown in FIG. 9. The insulation helps further slow and minimize the transfer of heat towards the front section of the door segment.

Referring to FIG. 8, extensions 76 to the front section 60 are illustrated in phantom. Further, a cover plate 78 is shown that is sandwiched between the extensions and the exterior surface of the front section 60. The cover panel typically comprises a glass, plastic or metal sheet that provides the associated door segment with a finished exterior appearance that is often more aesthetically pleasing than the exterior surface of the underlying front section. The use of the extensions and the cover panel is optional and does not significantly effect the operation or functionality of the associated door segment or the door 18, although the addition of the cover panel will often have a positive effect on the external surface temperature.

FIG. 9 is a cross sectional view of the top two door segments 18A&B and the header member 56 showing the configuration of each relative to each other when the associated door 18 is in its closed position. Of particular interest is the cross sectional view of door segment 18B which comprises one of two windowed door segments 18B&C of the illustrated embodiment. The windowed segments include a window module comprising three panes 90, 92 & 94 of temperature resistant glass mounted in top and bottom formed steel or aluminum receivers 81 & 84. The top and bottom receivers include vent openings 83A&B between the front two panes 90&92 that permit the convective air flow along the air path used to help keep the front sections 60 of the door cool during oven use. Like the non-windowed door segments, the windowed door segments include front and rear sections 82&86. The front and rear sections effectively sandwich the receivers to hold the window module in place. The sections are coupled together by a small number of screws or fasteners and are effectively separated by an intervening seal 70 essentially the same as the seal used in the non-windowed door segments. The windowed door segments also include (i) a small arcuate depression extends lengthwise from left to right along the top side of the front section to receive the cylindrical gasket 138 therein, and (ii) an indentation extends the entire length of the bottom surface in which the large rear primary door seal gasket 58 is received. Additionally, the front section 86 includes inlet and exhaust ports 72A&B.

As illustrated in FIG. 9, receivers of the window module butt directly up against the front and rear sections 82&86 of the windowed door sections 18B&C thereby providing a direct metal path for heat to be conducted between the oven chamber and the exterior surface of the front section. Practically, the receivers are relatively thin and heavily perforated, limiting the amount of heat energy conducted across them; however, in variations of the illustrated windowed door segment, a gasket material having a low coefficient of thermal conductivity can be placed in an intervening relationship between the receivers and the respective front and rear sections 86&82 to reduce the conduction of heat by way of the receivers.

Like the non-windowed door segments, variations of the windowed door segments can include extensions 76 on the front sections that permit a cover panel 78 to be placed over the exterior surface of the front section 86. In the windowed door sections, the cover panel is usually comprised of glass so not to hinder the ability of a user to view the interior of the oven chamber through the window module.

As can be appreciated, to maximize the efficiency, effectiveness and safety of an oven, the interface between the oven door 18 and the oven box 32 must be sufficiently sealed to prevent the heated air within the oven chamber from leaking out of the oven chamber 26. As described above, the interface between each of the segments 18A-D is sealed by the primary door seal gaskets 58 located between the interface of each of the top four door segments and between the header member 56 and the top door segment 18A as shown for instance in FIG. 9.

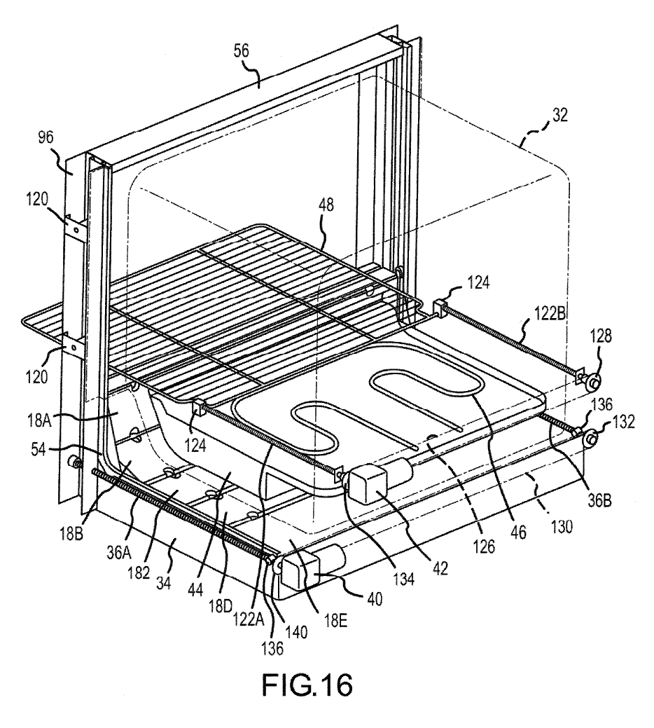

Vertically-orientated side door seals 98 are located in a vertical recess in each vertical frame member 96 for sealing the sides of the door 18 as shown in FIGS. 10 & 11. Specifically, the side door seals abut the side surfaces of the rear sections 62&82 of the top four door segments 18A-D as specifically illustrated in FIG. 13. The side door seals typically comprise similar materials and construction as the primary door seals 58. The side door seals are mounted to elongated vertically orientated plates 101. The plates are in turn mounted to the shafts 102 of two solenoids 104. The solenoids are mounted to the vertical frame members at vertically spaced locations as shown in FIG. 16 using solenoid brackets 120. The solenoids are electrically coupled to the control system of the oven and are activated when the door is put in motion to open or close the door. In its unactivated state, the shafts of the solenoids are fully extended biasing the associated side door seals against the sides of the door and a lip on the vertical portion 112 of the guide track 54 to effectively seal the vertical sides of the oven chamber. Referencing FIG. 13, the interface of the seal with the sides of the door segments prevents hot oven chamber air from escaping from the chamber between the sides of the door and the vertical frame members 96. However, if the side door seals 98 were sealed against the sides of the door segments only, hot air could escape through the openings in the vertical frame members 96 through which that the solenoid shafts pass. By providing the lip on the guide track and having a portion of the side door seal of each side seal against the lip of the respective track guide, hot air and gasses from the oven chamber are inhibited from leaking out of the solenoid shaft openings.

When a user activates the lower motor 40 to open or close the door 18, the control system sends current to the solenoids 104 causing them to retract as shown in FIG. 14, thereby pulling the respective side door seals 98 away from the sides of the door segments 18A-D. Accordingly, the door can be opened or closed without undue friction from the side door seals. When the door has finished moving and current flow to the lower motor is stopped, flow of current to the solenoids is also terminated causing the seals to return to their unactivated positions. Of note, in oven embodiments not having a battery power backup, the side seals will not retract when a user opens the door by turning the right lead screw 36A by way of the screw's socket head 52. While this will make the door to be more difficult to open, the amount of friction imparted by the seals is not sufficient enough to make the task unreasonably difficult.

Traditionally, oven chambers are not fully sealed along the bottom edge of an oven door. This permits fresh air to enter the oven chamber during its use. Further, omitting the bottom seal does not significantly effect the efficiency of a typical oven as hot air does not easily flow downwardly out of the doors bottom primarily because hot air rises and is also blocked by the denser cooler air located below the oven door under and in front of the oven chamber 26. In variations of the oven, the bottom edge of the interface between the oven door 18 and the oven chamber can be fully or partially sealed. For instance, a forward facing high temperature gasket (not shown) can attached to the oven box assembly proximate the bottom edge of the oven chamber's opening such that it provides a light bias against door segment 18D when the door is fully closed.

The operation of the door 18 and its associated motor driven mechanism can be described with reference to FIG. 18-20. Initially, when the oven door is closed, the top side of the top door segment 18A is in direct contact with the header member 56 as also illustrated in FIG. 9. The upper four door segments 18A-D are all vertically aligned with each other and as such sealed at their respective interfaces by both the cylindrical gasket 138 and the primary seal gasket 58. Additionally, the interface between the sides of the door segments and the oven chamber opening are also sealed by the side door seals 98. The bottom door segment 18E is canted rearwardly at an acute angle off of vertical and through its pivotal connection with the adjacent door segment 18D, it holds the other segments of the door in the closed position.

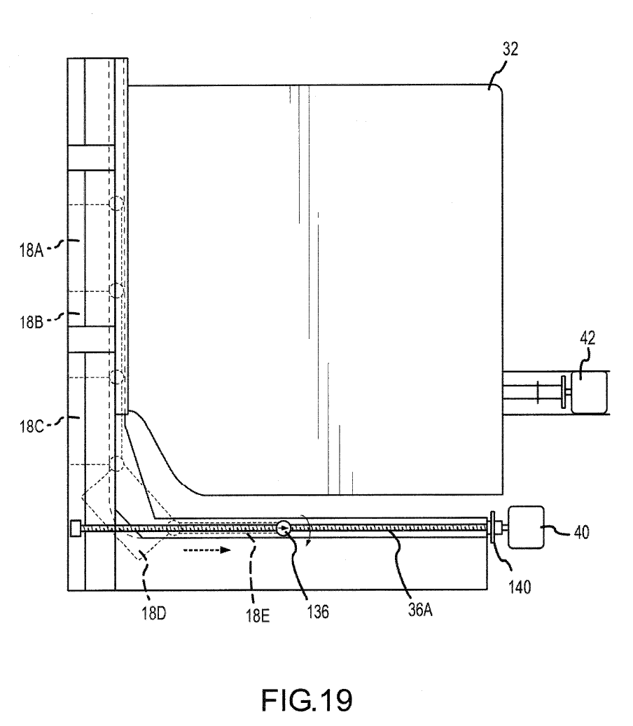

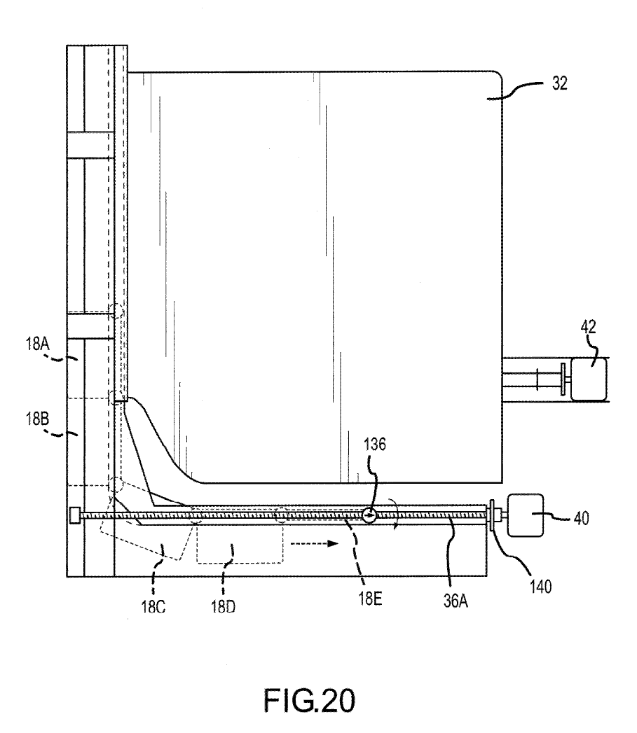

To facilitate the opening of the door as shown in FIGS. 19 & 20, a user activates the lower motor by depressing the appropriate button 24 on the front of the oven or on an oven control panel (or uses an other means such as remote control or voice activation). In preferred variations, depressing the appropriate button causes a control system to activate and control the operation of the lower motor as well as the solenoids 104 associated with the side door gaskets 98. The control system may also be interfaced with one or more sensors (not shown), such as infrared sensors, located along the door's path of travel. The sensors can be used to indicate to the controller when the door is open or closed as well as whether anything is obstructing the door that might prevent it from being closed. Other sensors can be provided to verify that the oven racks are properly retracted and fully contained within the oven chamber. One or more load sensors coupled with the motor 40 may also be utilized to help determine whether the door is fully opened or closed, or that something is hindering the normal operation of the door mechanism. Based on the information from the sensors and the control system's knowledge concerning the state of the oven, it will provide power to the lower motor to open or close the door. For instance, when the oven is in a self-cleaning cycle wherein the temperature in the oven chamber is extremely high, the controller may deactivate the buttons or other controls that permit a user to open the door. Advantageously, embodiments and variations of the oven need not utilize a self cleaning door locking mechanism found on prior art self cleaning ovens. In some variations, the motor may also have applied a holding current applied to it, which will also make it difficult or impossible to manually turn the crank socket 52 while the oven is in the self cleaning mode.

Although three buttons 24 are illustrated concerning the user's control of the oven door, in variations more or less buttons can be used or other types of switches can be substituted for the buttons. Further, in variations using a control system, the buttons can serve more than a single function depending on one or both of the state of the oven and the location of the door (i.e. whether the door is open or closed). For instance, one button can be an automatic open button wherein the door fully retracts when pushed once only momentarily. Another buttons may need to be held in to cause the door to open or close. Another button may be an emergency stop button. The operational actual configuration of the buttons can vary significantly as would be obvious to one of ordinary skill in the art given the benefit of this disclosure.

Once the appropriate button 24 or other input has been activated, the control system provides current to the lower motor 40 causing its shaft to rotate in the clockwise direction. The motor through the pulley coupler 140 causes the right lead screw 36A to rotate in the same direction. Further, the pulley coupler pulls the drive chain 130 or belt, which in turn rotates the left lead screw 36B clockwise through the left pulley 132. The lead screw in turn pulls the respective left and right nuts 136 which pull the bottom door segment 18E rearwardly along the horizontal portion 114 of the guide track 54. As indicated FIGS. 19 and 20, the bottom door segment pulls the other segments 18A-D downwardly along the guide track, around the radiused intersection 116 of the vertical and horizontal portions of the guide track, and for the lower segments rearwardly to expose the oven chamber 26 opening and permit a user access thereto.

When the appropriate button is pushed to close the door, the control system provides a reverse current to the lower motor 40 causing its shaft and the associated lead screws 36A&B to rotate in a counterclockwise direction. Accordingly, the nuts 136 move towards the front of the oven pushing the door segments 18A-E along the guide track back into the fully closed position in front of and sealing the oven chamber opening.

As indicated above, certain variations of the oven include one or more motor driven oven racks. A single motor driven oven rack 48 and its associated extension and retraction mechanism are illustrated primarily in FIGS. 15&16. The oven rack mechanism is similar to the mechanism used to open and close the oven door 18 comprising the upper motor 42 coupled with left and right lead screws 122A&B by a pulley coupler 134 and a pulley 128 respectively connected by an intervening drive chain 126. Left and right threaded blocks 124 are typically removably secured to the associated oven rack 48 proximate its back end and threaded through the respective left and right lead screws. As shown in FIG. 4, the oven rack is supported by a bracket 50 mounted to the side of the oven chamber that include a plurality of rollers to minimize the friction related to moving the rack, especially when loaded, in and out of the oven chamber while providing adequate support for the rack. In other variations and embodiments, the supports for the oven rack can vary substantially as would be obvious to one of ordinary skill in the art with the benefit of this disclosure.

Operationally, a user activates the appropriate switch or button (not shown) to extend the rack 48 partially from the oven as indicated in FIG. 16 after the oven door 18 has been opened to provide access to any food stuffs on the rack without having to reach into a heated oven chamber 26. In the variations having a control system, the control system may disable the operation of the oven rack while the oven door is closed. In other variations, the controller may automatically extend the rack after the oven door has fully retracted. To extend the rack, current is provided to the upper motor 42 to cause the motor's shaft and the lead screws 122A&B to rotate in a counterclockwise direction thereby pushing the threaded blocks 124 and the attached oven rack outwardly. To retract the rack, current in the opposite direction is provided to the motor to cause its shaft and the lead screws to rotate in a clockwise direction thereby pulling the rack into the oven chamber as indicated in FIG. 15.

### Another Embodiment of a Range or Oven Incorporating an Articulating and Retractable Door

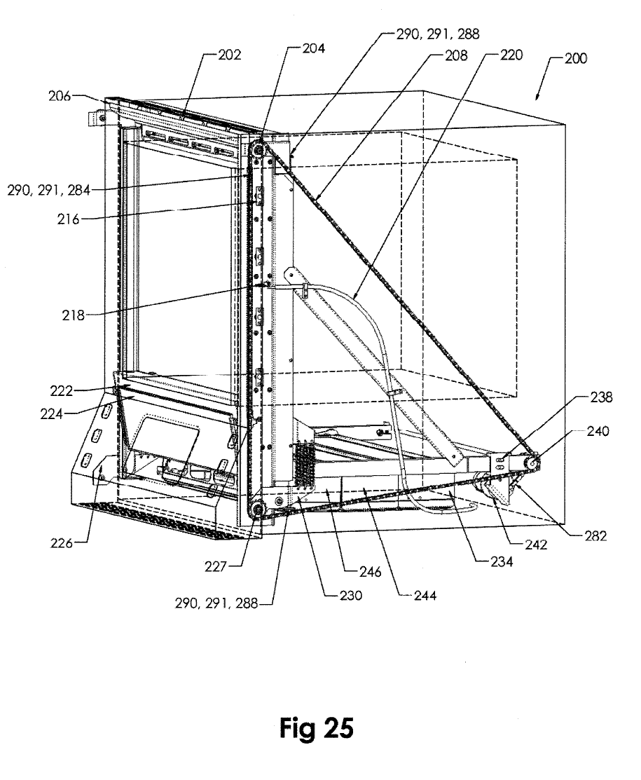

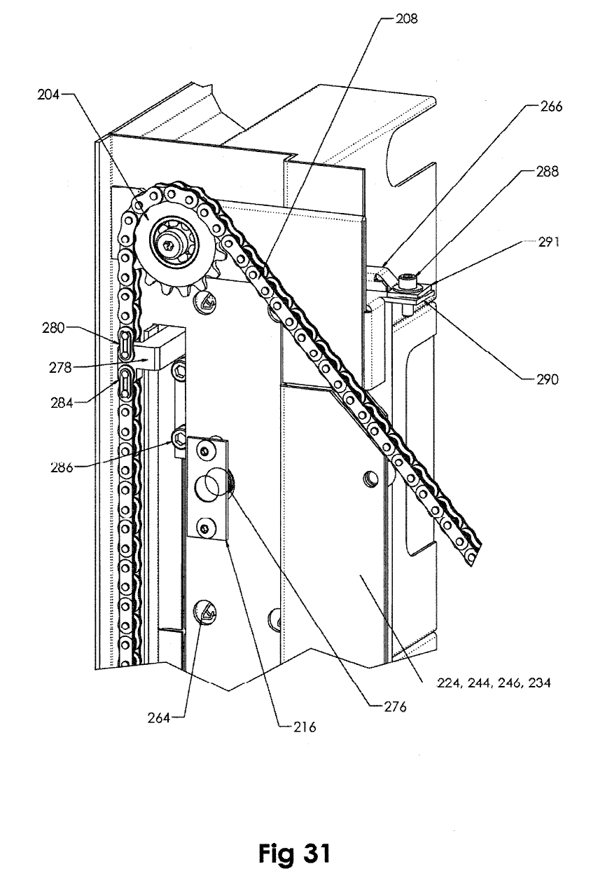

FIGS. 25-35 describe another embodiment of an oven 200 incorporating articulating retractable door. In many respects, the various door segments 224, 234, 244 & 246 are generally similar in their construction and configuration to the construction of all but the bottommost door segment described above in relation to the preceding embodiment. Segments having windows and those not having windows are also contemplated. In general concerning FIGS. 25-35, only the elements that are described herein below and relate to the differences between this embodiment and the preceding embodiment are numbered. It is appreciated that the construction and configuration of this embodiment is generally similar to that of the preceding embodiment save for the differences specifically discussed in this section.

This embodiment, however, differs from the previously described embodiment in several significant ways. First, a chain drive is utilized in place of the lead screw mechanism to open and close the door. Second, the retractable and vertical side door gaskets retract from a deployed position to a retracted position through pivotal movement as actuated by a cable and an associated drive mechanism in contrast to the gasket assembly of the preceding embodiment which was retracted generally linearly by way of one or more solenoids. Third, the controls and displays utilize to operate the oven and to assess the temperature within the oven chamber have been relocated to a position below the door. Fourth, the top door segment includes a cap/spill catch assembly that routes the door airflow into the header airflow when the door is closed but prevents food spillage from entering into the top door segment when the door is open. Finally, multilayer front panels are described comprising first decorative layers that are covered by and protected by transparent second layers.

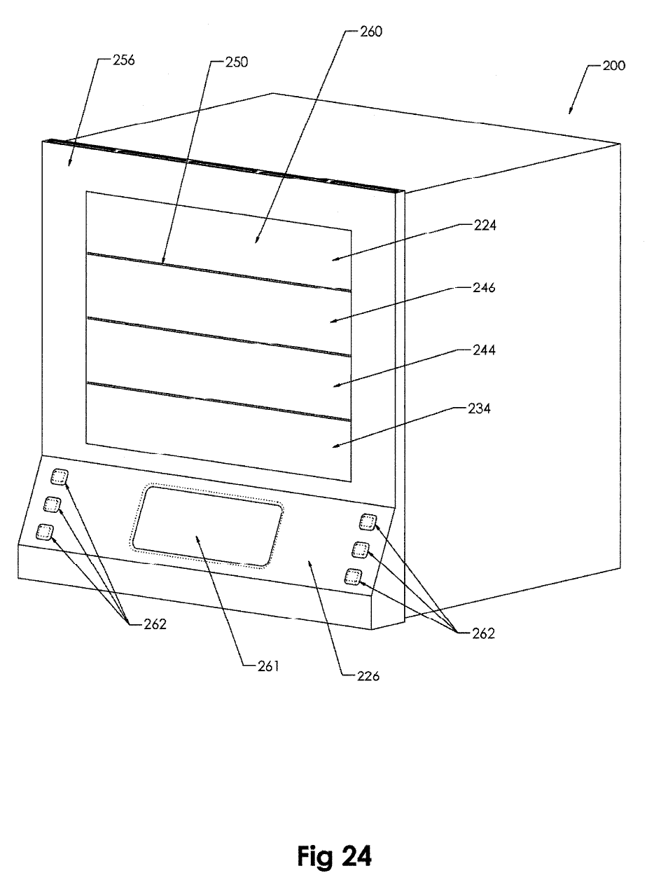

Referring primarily to FIG. 24, the oven controls 261 including the door controls 262 are mounted below the oven door opening where they are easily accessible to people of short stature and handicapped persons. Generally, the controls will be placed in this location only on in-cabinet or in-the-wall ovens and not traditional ranges. As shown, the controls are mounted on an air intake shroud 226 which is open on the bottom to permit fresh room temperature air to be drawn into the oven enclosure. The controls are situated on a face of the shroud that is canted about 25° from vertical and faces partially upwardly. In the illustrated variation, two sets of door controls 262 are provided; one along each of the respective left and right edges of the oven. This permits ease of operation from either side of the oven without having to reach across the oven when the doors open and risk being burned. The oven controls 261 are located in the center of the canted shroud face. It is to be appreciated that the actual configuration of the controls and associated displays can vary substantially from oven to oven.

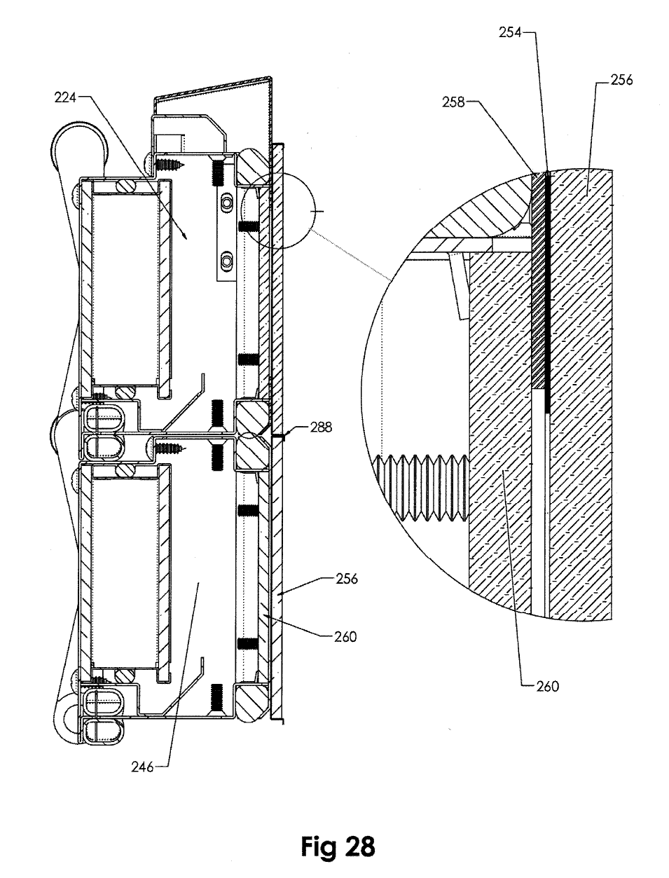

As mentioned above, the front face of the oven including the front face of each of the door segments as well as the casing surrounding the door opening comprise a multilayer panel system. The multilayer panel system is best illustrated in FIG. 28. A first layer 254 typically comprises a material having visually pleasing characteristics, such as the painted surface, a stainless steel surface or bronze surface. This layer may comprise a very thin piece of metal, such as stainless steel or bronze, or it may comprise a thin coating, such as paint. It is placed on top of the underlying substrate 258 of the door segment and/or the oven's front face. Over this layer, a second layer 256 of a transparent material is provided effectively covering the first layer. Typically, the second layer will comprise glass sheet, although other suitable transparent materials can be used as well.

Specifically, FIG. 28 is a cross-sectional view of two windowed door segments 224 & 246. A close-up of one section of one of the door segments is also provided. As illustrated the first layer 254 extends in front of the sheet-metal portion or steel substrate portion 258 of the door segment and slightly there beyond overlapping the door segment's window 260. Accordingly, the first layer does not substantially or significantly block a user's ability to view the interior of the oven chamber through a door segment window. The first layer may be attached to the underlying substrate in any suitable fashion including but not limited to finish screws, adhesive or clips. It is further appreciated than the first layer may be removable and interchangeable with layers having different finishes and designs. Accordingly, a user may be able to replace this layer to update the look of the oven.

The multilayer decorative mask assembly as described above can be applied to the face of the oven, the face of the oven door segments or both. Furthermore, the multilayer decorative mask can also be used in conjunction with traditional ovens and ranges.

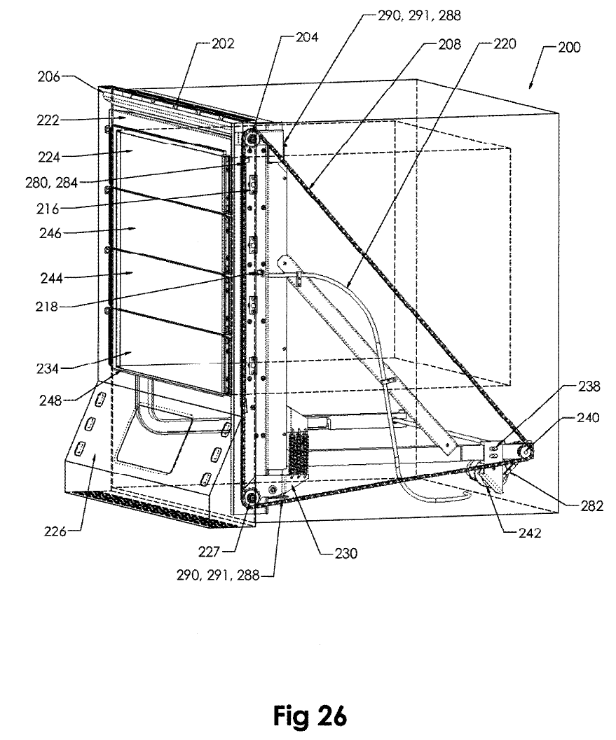

Referring generally to FIGS. 25, 26 & 31, a drive chain assembly is utilized in place of the lead screw assembly of the previously described embodiment to facilitate the opening and closing of the segmented oven door. The chain 208 is typically disposed in a generally vertical plane and located on either the left or the right of the oven chamber and is illustrated in the figures proximate the right side of the oven chamber. The chain extends in a nearly continuous loop downwardly from a first master link 284, which is connected to a door segment linkage 278 to and around a first idler sprocket 227. From the first idler sprocket, the chain extends generally horizontally to and around a driver sprocket 240. From the driver sprocket, the chain extends upwardly and forwardly to and around a second idler sprocket 204. The chain then extends downwardly to a second master link 280, which is also coupled to the door segment linkage. As illustrated, the chain comprises a typical roller chain but it is appreciated that in variations, different types of chains can be utilized or the chain may be replaced altogether with a cable or a belt.

As mentioned above, on the two master links 280, 284 of the chain 208 are attached to a door segment linkage 278. The door segment linkage is typically attached to the upper door segment 224; however, variations having a linkage attached to the lowermost door segment or even an intermediate door segment are contemplated. The means of attaching the door segment linkage to the corresponding door segment, such as screws 278, may facilitate or permit the adjustment of the chain pitch.

The chain is driven by the driver sprocket 240. The driver sprocket is typically either directly connected to a drive shaft of a suitable electric motor 242, or as illustrated in FIG. 25, the drive sprocket may be connected to another sprocket or a pulley that is connected to the motor 242 by way of a second chain 282, belt or pulley. In the illustrated variation, the gear motor is attached to the framework of the oven by way of an adjustable bracket 238. Accordingly, the tension in the second chain 282 can be adjusted as necessary.

Operationally, when the drive sprocket 240 is rotated in a clockwise fashion, the chain 208 also moves clockwise pulling the door upwardly into its closed position. Conversely, when the drive sprocket is rotated counterclockwise, the chain also moves counterclockwise and pulls the door downwardly into its open position. A variety of mechanisms can be utilized to determine whether the door is either fully open or fully closed. In some variations, electronic sensors may be utilized that sense when the door is either in its fully open or closed position and signal the ovens control system to shut off the electric motor 242. Additional sensors may also be utilized to determine the relative position of the door during its travel from the open and closed or closed to open positions. Mechanical sensors can also be utilized for essentially the same purpose. For instance, buttons or switches may be provided that are depressed by the segment linkage 278 when the door is either fully open or fully closed. In yet other variations, a load sensor may be utilized, such as at the location of the electric motor, which is adapted to turn off the gear motor when a load exerted by the chain exceeds a predetermined level.

Referring to either FIG. 25 or 26, a chain tensioning device 230 is associated with the first idler pulley 227. The chain tensioning device comprises an elongated plate is pivotally connected to the oven framework proximate the center of its span with one or more biasing springs coupled with the plate at a distal end and the first idler pulley connected to the proximal end. Accordingly, a relatively constant chain tension can be maintained over the life of the product even as the chain 208 stretches through use.

It is to be appreciated that the actual configuration of the roller chain drive assembly can vary substantially in variations of the present embodiment 200 and in alternative embodiments as well. For instance, the drivetrain assembly could be located proximate the left side of the oven instead of the right side. A third idler pulley can be located at the top right corner of the oven such that the chain does not extend diagonally from the second idler pulley to the drive pulley. As mentioned above, a belt or cable can be utilized in place of the roller chain 208. In yet another variation, the segmented door could include a bottommost segment similar to the bottommost segment described in the preceding embodiment that never extends in front of the oven chamber opening. The segment linkage could be attached to this bottommost segment and move generally horizontally below the oven chamber's bottom side accomplishing the same task of moving the door between its open and closed positions.

One potential issue concerning a flexible or articulated sliding oven door is adequately sealing the left and right sides of the door so that hot air from the oven chamber does not escape into the atmosphere reducing the efficiency of the oven. Additionally, escaping air would have a tendency to heat up the surrounding regions of the oven, perhaps enough so as to potentially burn someone who accidentally touches the front of the oven. Tightly biased seals along these respective edges of the door and frame interfaces tend to make the opening and closing of the door much more difficult. Accordingly, embodiments of the present oven utilized retractable side door seals. In the previously described embodiment, the seals are moved between deployed and retracted positions by way of one or more solenoids. Specifically, the solenoids move a plate to which the associated gaskets are attached linearly towards or away from a side of the oven door.

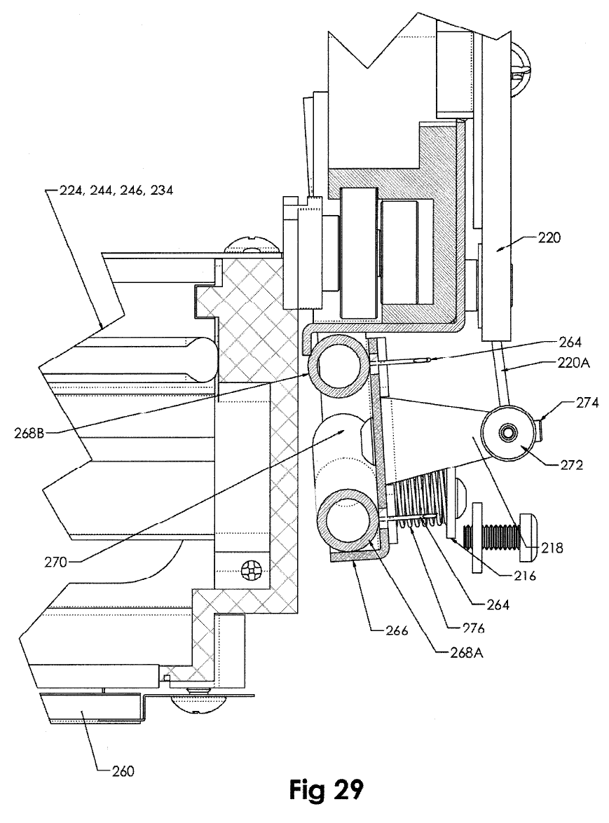

In the current embodiment 200, an elongated vertically-disposed swinger plate 266 that is pivotally mounted to the oven framework is utilized to deploy and retract an associated side seal. The side seal mechanism and assembly is best illustrated in FIGS. 29, 30, 32 and 33. Also, in this embodiment, the generally tubular gaskets 268 are secured to the swinger plate as to generally form a channel 270 between a front portion 268a of the gasket and a rear portion 268b of the gasket. This channel is operatively coupled to vacuum tunnel 236 that is in turn coupled with the header 206 of the door framework. Effectively, this configuration facilitates the removal of hot air that enters this chamber through the header exhaust ducts 202. Specifically, by creating a lower pressure region between the front and rear portions of the gasket any hot air they would normally leak across the horizontal door segment joints, such as joint 250, will be drawn into these channels and exhausted out of the top of the oven. Accordingly, the various door segment joints, especially externally, are less likely to heat up to a temperature that could burn a person touching the door proximate those segment joints.

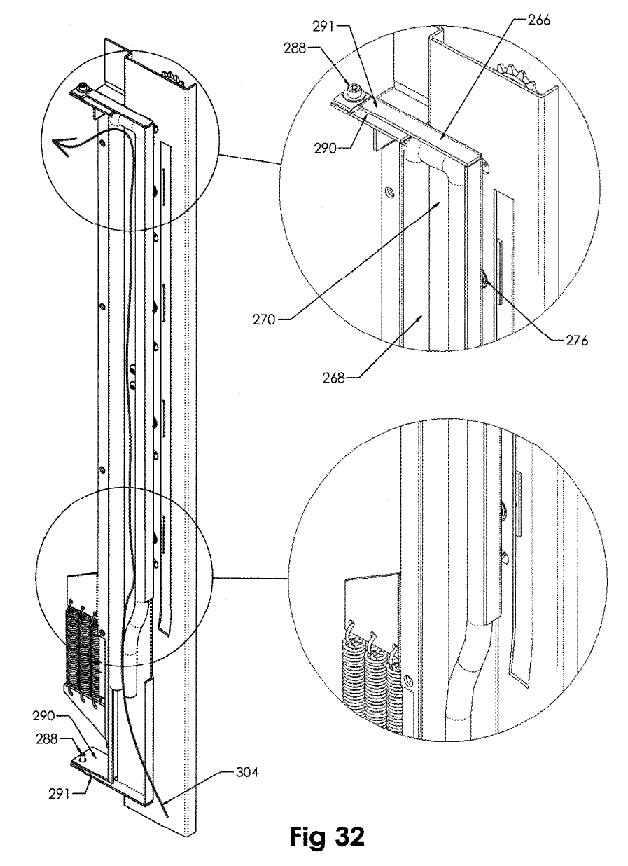

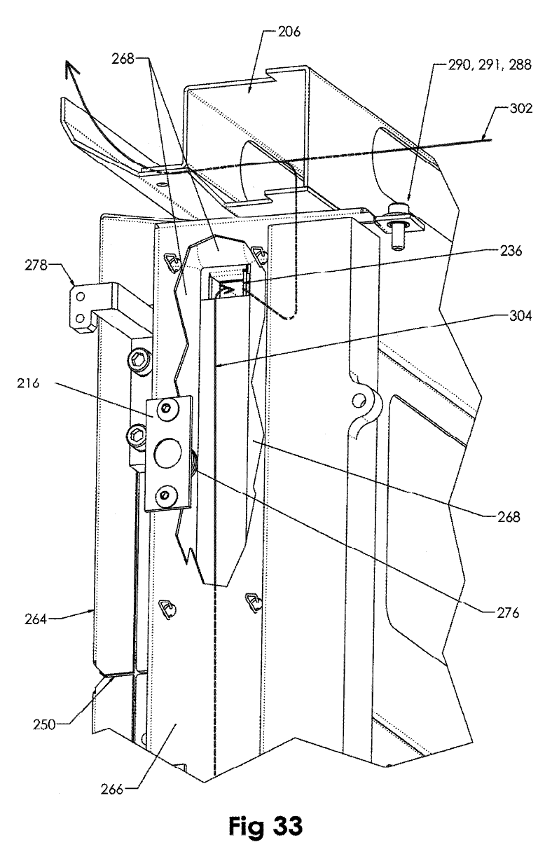

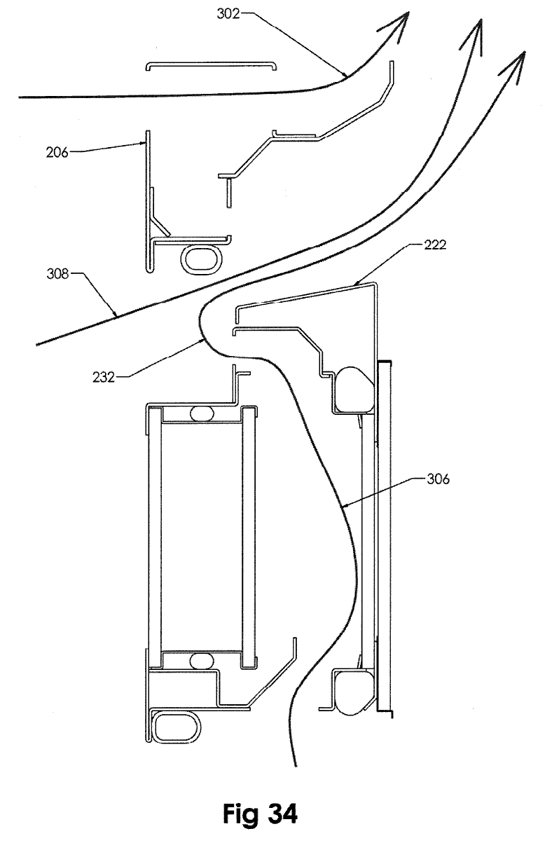

The gasket 268 can comprise any suitable material having low thermal conductivity and relatively high temperature resistance, such as but not limited to braided fiberglass rope. The gasket, as illustrated in the various figures is secured to the swinger plate by way of a plurality of gasket clips 264 that are passed through associated openings in the swinger plate snapping in place therein. As best illustrated in FIG. 32, the gasket is disposed in a generally inverted U-shaped configuration with respective ends of the gasket being located proximate the bottom end of the swinger plate 266. Referring primarily to FIG. 32, integral arms 291 extend outwardly from the top and bottom sides of the plate and are pivotally secured to mounting tabs 290 of the oven framework with a pivot bolt 288. Accordingly, the swinger plate can pivot between its deployed and attracted positions.

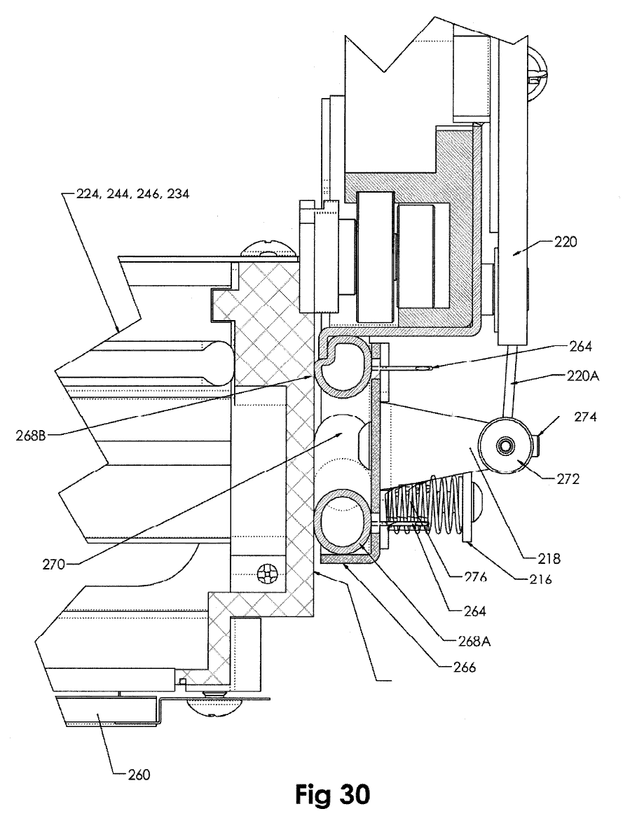

Referring to FIGS. 26 & 30, the swinger plate 266 is normally biased against the side of the oven door by a plurality of side seal return springs 276. In the illustrated embodiment, there are four springs on each side of the oven. The springs are effectively held in place by return spring traps 216 that are riveted or otherwise attached to the oven framework. As shown in FIG. 30, the rear portion of the gasket 268b seals the side of the door relative to the oven chamber. The front portion of the gasket 268a also seals against the side of the door and creates the aforementioned air channel 270.

A control horn 218 extends perpendicularly outwardly from a back face of the swinger plate 266 terminating at a retainer collar 272 and associated collar set screw 274. The collar set screw is adapted to receive a first end of a control cable 220A therein. As best illustrated in FIG. 25, the control cable and its associated housing 220 extend across the side of the oven and down to a location under and behind the oven chamber. The second end of the control cable is typically attached to any suitable actuator that is adapted to pull or release the cable. Accordingly, when the cable is pulled, the end of the horn moves towards the end of the cable housing and pivots the swinger plate 266 outwardly from the side of the oven door. As can be appreciated, the operation of the linear actuator is controlled by the oven's controller and is typically actuated when the door is being moved between its open and closed positions.

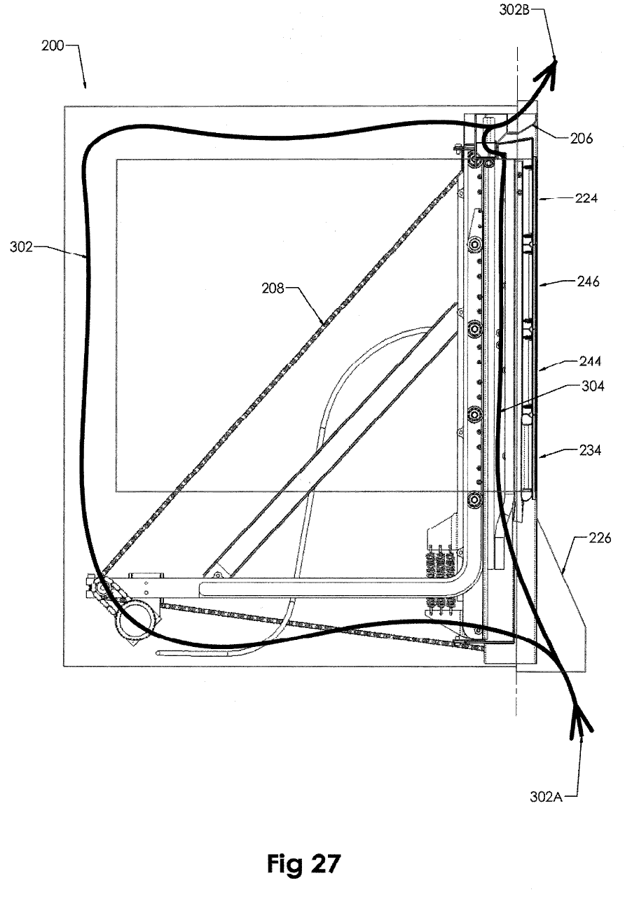

Airflow around an oven chamber is often necessary in ovens so that the exterior oven enclosure does not become too hot for the surrounding surfaces in which it is mounted. Accordingly, it is common to draw air into the space between the oven chamber and the exterior oven housing by way of inlets located proximate the bottom front face of the oven. In the instant embodiment, fresh air 302a is provided egress by way of the oven shroud 226. As indicated in FIG. 27, the majority of the airflow travels along the bottom of the oven chamber in a first airstream 302, upwardly along the back of the oven chamber, and forwardly along the top of the oven chamber. The airflow 302b is exhausted across the door frame header assembly 206 and out in exhaust ducts 202 at the top of the oven's front face. A blower assembly may be provided to facilitate the necessary airflow.

As shown in FIG. 27 of the current embodiment, the airflow is split as it enters the oven through the inlet shroud. A second stream 304 of air is drawn upwardly into the gasket air channel 270 and eventually across the header assembly 206 and out the exhaust ducts 202. FIG. 33 indicates the presence of a vacuum tunnel 236 connecting the airflow 304 in the gasket air chamber with a higher volume of airflow 302 from the blower across the header channel. Effectively, the higher flow across the header channel creates a partial vacuum in the vacuum tunnel, which pulls air out of the gasket air channel creating and facilitating the secondary airflow.

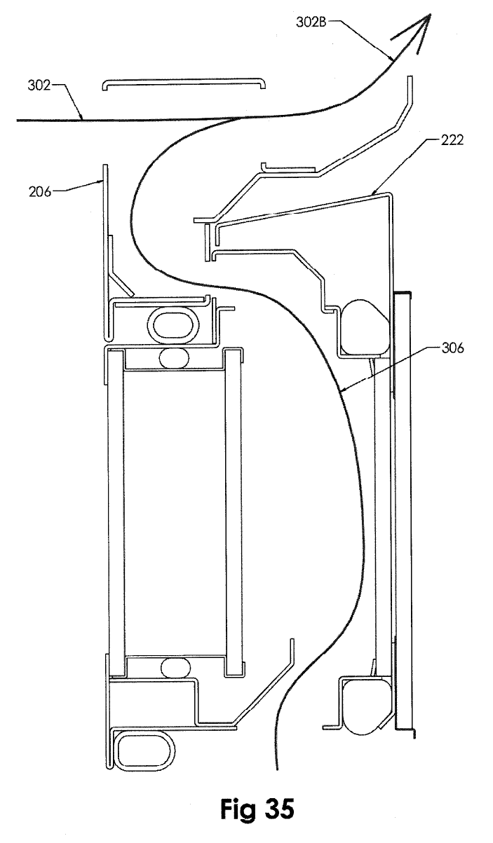

The topmost oven door segment 224 differs slightly from that of the three lowermost door segments 246, 244 & 234 in that it includes a spilt catcher assembly 222 mounted over and above its top side airflow outlets. The primary purpose of this assembly as the name suggests is to prevent spilled food material from entering into the exhaust outlets as food is removed from the oven when the door is open. FIG. 34 illustrates the airflow 306 through and out of the topmost door segment when the doors partially open. Specifically, the spill catcher covers the horizontally disposed topside airflow outlets and redirects the airflow out of vertically disposed outlets 232 on the rear side of the spill catcher assembly and into the hot air stream 308 exiting the oven chamber. FIG. 35 indicates the airflow when the door is closed. Specifically, the vertically disposed outlets of the spill catcher assembly 222 mate with openings in the header assembly 206, which are in fluid communication with the primary airflow 302 over the header assembly and out of the oven. As with the side seal air channel 270, the greater primary flow across the header assembly creates a vacuum which draws airflow through the aligned door segments from an air intake 248 on the bottom of the bottommost segment 234 creating a third stream 306 of air that is utilized to maintain the front surface of the door at a relatively cool temperature.

### Other Embodiments and Other Variations

The various preferred embodiments and variations thereof illustrated in the accompanying figures and/or described above are merely exemplary and are not intended to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

For instance, the embodiment described herein relates to a motor controlled articulating door comprising a plurality of segments. In variations and alternative embodiments, the door may not comprise segments that are mechanically attached to each other. Rather the door may comprise one or more layers of a flexible sheet material, such as a corrugated stainless steel sheet stock that flexes at the associated folds in the material to retract to a position under, over or to the side of the oven chamber opening. In one alternative embodiment, the door comprises two sheets of corrugated metal that are separated from each other by an air space when the door is closed to minimize the transfer of heat energy from the oven chamber to the outside surface of the door.

In yet other variations and embodiments of the oven, the door may retract or open sideways and reside when open along the left or right side of the oven box. The door can also be configured to open upwardly and be located above the oven box when in the open position. Further, the door can comprise two sections each which open and close from an opposite side as the other and meet together when the door is closed presumably in front of the oven chamber opening. The number of segments utilized is also variable wherein more segments would permit the door to negotiate a tighter radius during opening and closing and wherein less segments would require a greater radius but the use of a lower number of segment interfaces might make the door more efficient thermally.

The construction of the door segments can also vary substantially. For instance, pieces comprising other metals made from various manufacturing techniques can be used in place of the pieces fabricated from sheet steel as described herein above. The front sections may be made of a high temperature plastic in other variations. Different air path configurations can be utilized as well, or in other embodiments the air path chamber can be eliminated altogether. The manner in which the segments are joined together can vary significantly and substantially as would be obvious to one or ordinary skill in the art given the benefit of this disclosure. In some variations, one or a plurality of electric fan(s) can be provided underneath the bottom insulated door segment to actively blow air through the door's air path to more effectively cool the door. Alternatively a “built-in-to-the-wall” duct and draft fan could be used to draw cool room air into the air chase of the door segments.

The motor and its associated linkage comprising the door actuation mechanism can also vary substantially in other alternative embodiments. For instance, the tracks can be located or formed in the door segments and the corresponding wheels can be attached to the vertical frame members. In other variations, the track and wheel guides can be replaced altogether. Further, other mechanisms and different types of linkage can be used in place of the lead screws and associated nuts. For instance, in one alternative embodiment the door can be pulled closed via a cable threaded over the top of the oven chamber and is secured to a motor driven spindle. In yet other embodiments, the motorized system can be done away with completely with the door being opened and closed manually. In a manually closed or motor driven oven door, a latch mechanism may also be provided, as well as a counterbalance spring or mechanism.

It is appreciated that while the retractable and articulating door is described herein with reference to an oven, doors of similar design can be used in various other appliances, such as but not limited to dishwashers, microwaves, washers, dryers, refrigerators and trash compactors.

We claim:

1. An oven comprising:
an oven chamber and associated framework having a plurality of closed sides and at least one vertically disposed substantially open side, the substantially open side being located on a front face of the oven;
one or more heating implements contained within the oven chamber;
a flexible oven door, the oven door being adapted to move between open and closed positions, a substantial portion of the oven door being generally horizontally disposed in the open position, and the oven door being generally vertically disposed in a closed position; and
one or more oven controls, the oven controls adapted to set a desired cooking temperature within the oven chamber;
wherein the one or more oven controls are located generally on the front face vertically below the substantially open side.

2. The oven of claim 1 further comprising:
an electric motor assembly, the electric motor assembly being coupled with the flexible oven door and adapted to move the oven door between the open and closed positions; and
one or more door controls operatively coupled to a electric motor, the controls adapted to signal the electric motor to move the oven door between the open and closed positions when activated by a user;
wherein the one or more door controls are also located generally on the front face of the oven vertically below the substantially open side.

3. The oven of claim 2, wherein the electric motor is operatively coupled to the flexible oven door by way of an elongated generally flexible member.

4. The oven of claim 3, wherein the elongated flexible drive member comprises at least one of a chain, a cable and a belt.

5. The oven of claim 1, wherein the flexible door comprises three or more pivotally-interconnected segments, wherein each segment comprises (i) a top side, (ii) a bottom side, (iii) a left side, (iv) a right side, (v) a front side, (vi) a back side and (vii) a hollow interior portion that extends from the bottom side to the top side, the top side and the bottom side of each segment each include one or more openings spaced thereon, the one or more of openings of one segment being adapted to align with a corresponding one or more of openings on adjacent segments.

6. The oven of claim 5, wherein a top segment of the three or more pivotally-interconnected segments includes spill catcher cover assembly mounted over the top side of the top segment, the spill catcher cover being adapted to hinder solid and liquid food stuff spilled onto the spill catcher cover from entering into the hollow interior portion of the top segment through the one or more of openings spaced on the top side.

7. The oven of claim 5, wherein the spill catcher cover assembly includes one or more vertically orientated openings in fluid communication with the one or more openings of the top side and hollow interior of the top segment.

8. The oven of claim 7, further comprising a header assembly mounted to a top edge of the substantially open side, the header assembly including: (i) a first flow path terminating at exhaust outlets adapted to channel a first airflow circulating around the exterior of the oven chamber out of the oven; (ii) a second flow path for directing a second air flow from header inlets in fluid communication with the one or more vertically orientated openings of the spill catcher cover to a convergence with the first flow path, whereby in operation the first airflow in the first flow path causes the creation of a lower pressure region in the second flow path thereby pulling a second airflow upwardly through the three or more pivotally-interconnected segments to help cool the door.

9. The oven of claim 8, comprising a pair of vertical side seals, each side door seal spanning between one of two opposing vertical sides of the oven door and a corresponding side of the oven door framework, each side door seal comprising one or more gaskets having a first portion generally parallel to and spaced from a second portion forming a gasket airflow channel, the airflow channel being fluidly coupled to the first flow path, whereby in operation the first airflow in the first flow path causes the creation of a lower pressure region in the gasket airflow channel thereby pulling a third airflow upwardly in the gasket airflow channel.

10. The oven of claim 2 further comprising (i) at least one oven rack, (ii) a second electric motor, and (iii) a linkage, the oven rack being operatively coupled with the second electric motor by the linkage, the second electric motor and the linkage being adapted to selectively move the rack between an extended position and a retracted position when activated, the oven rack extending at least partially out of the oven chamber when in the extended position, and the oven rack being substantially contained within the oven chamber when in the retracted position.

11. An oven including an oven chamber having: (i) a plurality of closed sides and at least one substantially open side; (ii) an oven framework and associated enclosure, the enclosure being generally spaced from the oven chamber; (iii) an articulating door comprising three or more pivotally interconnected segments, the interconnecting segments having at least partially hollow interiors and each segment including openings into the hollow interiors wherein a contiguous air path is created between a top side of the door and a bottom side of the door when the door is closed over the substantially open side; (iv) an air intake into the oven located proximate a bottom of the oven; and (v) an air outlet located proximate a top of the oven; wherein when operating the oven is adapted to provide (a) a first airflow from the air inlet between the exterior of the oven chamber and the enclosure and out the air outlet, and (b) a second flow from the air inlet through the contiguous air path and out the air outlet.

12. The oven of claim 11, further having a pair of substantially vertically disposed side seals, each side seal located between one of two opposing vertical sides of the oven door and a corresponding side of the oven door framework, each side seal adapted to form an airflow channel with the side of the oven door when in the closed position, wherein when operating the oven is adapted to provide a third airflow from the air inlet through the airflow channel and out the air outlet.

13. The oven of claim 11, further having a pair of substantially vertically disposed side seal assemblies, each side seal assembly located between one of two opposing vertical sides of the oven door and a corresponding side of the oven door framework, wherein the side seal assemblies each comprise a plate and one or more gaskets coupled to the plate, the plate being pivotally coupled to the oven framework and adapted to move between retracted and deployed positions wherein (i) the one or more gaskets are in contact with one of the two opposing vertical sides of the oven door when in the deployed position, and (ii) the one or more gaskets are either (a) not in contact with one of the two opposing vertical sides of the oven door or (b) only incidentally in contact with one of the two opposing vertical sides of the oven door when in the retracted position.

14. The oven of claim 13, wherein the one or more gaskets are not in contact with one of the two opposing vertical sides of the oven door when in the retracted position.

15. The oven of claim 13, wherein the one or more gaskets comprises front and rear generally vertically orientated gasket portions that are spaced apart from each other to form a channel.

16. An oven including an oven chamber having: (i) a plurality of closed sides and at least one substantially open side; (ii) an oven framework and associated enclosure, the enclosure being generally spaced from the oven chamber; (iii) an articulating door comprising three or more pivotally interconnected segments; (iv) an electric motor operatively coupled with the articulating door to facilitate the opening and closing of the door; (v) one or more door switches; (v) a electronic controller operatively coupled to the electric motor adapted to control the operation of the electric motor at least partially in response to a signal from the one or more switches.

17. The oven of claim 16, wherein the electric motor is operatively coupled with the articulating door by one of a chain, a cable and a belt.

18. The oven of claim 16, further comprising left and right side seal assemblies adapted to seal the interfaces between the left and right sides of the oven door and the left and right sides of the oven door opening respectively and hinder the escape of hot gas from the oven chamber through the interfaces.

19. The oven of claim 16, further comprising a multilayer front face, the multilayer front face including: a first decorative layer coupled to an exterior front surface of the oven enclosure: and a protective transparent or translucent layer substantially covering the first decorative layer.

20. The oven of claim 16, wherein front surfaces of the each door segment include a multilayer front face, the multilayer front face including: a first decorative layer coupled to an exterior front surface of the oven enclosure: and a protective transparent or translucent layer substantially covering the first decorative layer.
